(19) United States
(12) Patent Application Publication
(10) Pub. No.: US 2022/0185585 A1
(43) Pub. Date: Jun. 16, 2022

(54) OBJECT PICKER

(71) Applicant: NEXTSHIFT ROBOTICS, INC., Lowell, MA (US)

(72) Inventors: Stephen Toebes, Sunderland, MA (US); Mary Ellen Sparrow, Lowell, MA (US)

(21) Appl. No.: 17/603,271

(22) PCT Filed: Mar. 16, 2020
(86) PCT No.: PCT/US2020/022991

§ 371 Date: Oct. 12, 2021

Related U.S. Application Data
(60) Provisional application No. 62/819,061, filed on Mar. 15, 2019.

(51) Int. Cl. B65G 1/04; B65G 1/137; B66F 9/06; G05D 1/02; B60P 1/44; B60P 1/64

(52) U.S. Cl. CPC B65G 1/0492; B65G 1/1371; B66F 9/063; B65G 2203/0216; B60P 1/4414; B60P 1/6427; B65G 2203/041; G05D 1/0225

(57) ABSTRACT

An autonomous mobile robot including frame defining a payload holding area with a payload seating surface, and having a wheeled traverse system dependent from the frame for substantially free unrestricted roving of the autonomous mobile robot on a riding surface in a facility space, at least one drive section connected to the frame, and at least one motor defining at least one independent degree of freedom; and an articulated pick arm dependent from the frame, the articulated pick arm having an end effector configured so as to stably hold a container therewith, and being operably connected to the at least one motor so that the at least one independent degree of freedom extends and retracts, and raises and lowers the articulated pick arm defining a range of motion of the end effector spanning from an elevation below a lowermost level of the payload seating surface onto the payload seating surface.

### CROSS-REFERENCED TO RELATED APPLICATIONS

This application is a National Stage of International Application No. PCT/US2020/02291, having an International Filing date of 16 Mar. 2020, which designated the United States of America, and which International Application was published under PCT Article 21(2) as WO Publication No. 2020/190877 A1. This application is a non-provisional and claims the benefit of U.S. provisional patent application No. 62/819,061 filed Mar. 15, 2019. The disclosures of the above-mentioned international and provisional applications are incorporated herein by reference in their entireties.

### BACKGROUND

### 1. Field

The exemplary embodiments generally relate to transportation of items, and more particularly, to automated transportation of items between multiple points.

### 2. Brief Description of Related Developments

When transporting items, such as containers, there may be a desire to pick up a container from the ground or from a location that is lower than a predetermined height at which a mobile robot carries the container. Picking up such containers may be performed with a forklift type mechanism that extends from the mobile robot. The forklift type mechanism includes tines that extend from the mobile robot increasing the overall length of the mobile robot. The tines are inserted underneath the container and the container is carried by the tines in a cantilevered manner where the tines extend outward from a frame of the mobile robot. In addition, the forklift type of lift generally has to lower the carried container to a container holding location prior to picking up another different container.

### BRIEF DESCRIPTION OF THE DRAWINGS

The foregoing aspects and other features of the disclosed embodiment are explained in the following description, taken in connection with the accompanying drawings, wherein:

FIG. 1A is a schematic block diagram of a logistic/manufacturing space incorporating aspects of the present disclosure;

FIG. 1B is a schematic illustration of a portion of the logistic/manufacturing space in accordance with aspects of the present disclosure;

FIG. 2 is a schematic block diagram of an autonomous mobile robot in accordance with aspects of the present disclosure;

FIG. 3A is a schematic illustration of the autonomous mobile robot of FIG. 2 with an articulated pick arm in a retracted configuration in accordance with aspects of the present disclosure;

FIG. 3B is a schematic illustration of the autonomous mobile robot of FIG. 2 with an articulated pick arm in an extended configuration in accordance with aspects of the present disclosure;

FIG. 3C is a schematic illustration of a portion of the autonomous mobile robot of FIG. 2 in accordance with aspects of the present disclosure;

FIGS. 3D-3G illustrate a container picking sequence of the autonomous mobile robot of FIG. 2 in accordance with aspects of the present disclosure;

FIGS. 3H-3J illustrate a container picking sequence of the autonomous mobile robot of FIG. 2 in accordance with aspects of the present disclosure;

FIG. 3K is a schematic illustration of a container transfer from an elevated storage space with the autonomous mobile robot of FIG. 2 in accordance with aspects of the present disclosure;

FIG. 4 is a schematic illustration of a portion of the autonomous mobile robot of FIG. 2 in accordance with aspects of the disclosed embodiment;

FIG. 5 is a schematic illustration of the autonomous mobile robot of FIG. 2 in accordance with aspects of the present disclosure;

FIG. 6 is a schematic illustration of the autonomous mobile robot of FIG. 2 in accordance with aspects of the present disclosure;

FIG. 7 is a schematic illustration of the autonomous mobile robot of FIG. 2 in accordance with aspects of the present disclosure;

FIG. 8 is a schematic illustration of the autonomous mobile robot of FIG. 2 in accordance with aspects of the present disclosure;

FIG. 9 is a schematic illustration of autonomous mobile robot navigation in accordance with aspects of the present disclosure;

FIG. 10 is a schematic illustration of autonomous mobile robot navigation in accordance with aspects of the present disclosure;

FIG. 11 is a schematic illustration of autonomous mobile robot navigation in accordance with aspects of the present disclosure;

FIG. 12 is a schematic illustration of autonomous mobile robot navigation in accordance with aspects of the present disclosure;

FIG. 13 is a flow diagram of a method in accordance with aspects of the present disclosure; and

FIG. 14 is a flow diagram of a method in accordance with aspects of the present disclosure.

### DETAILED DESCRIPTION

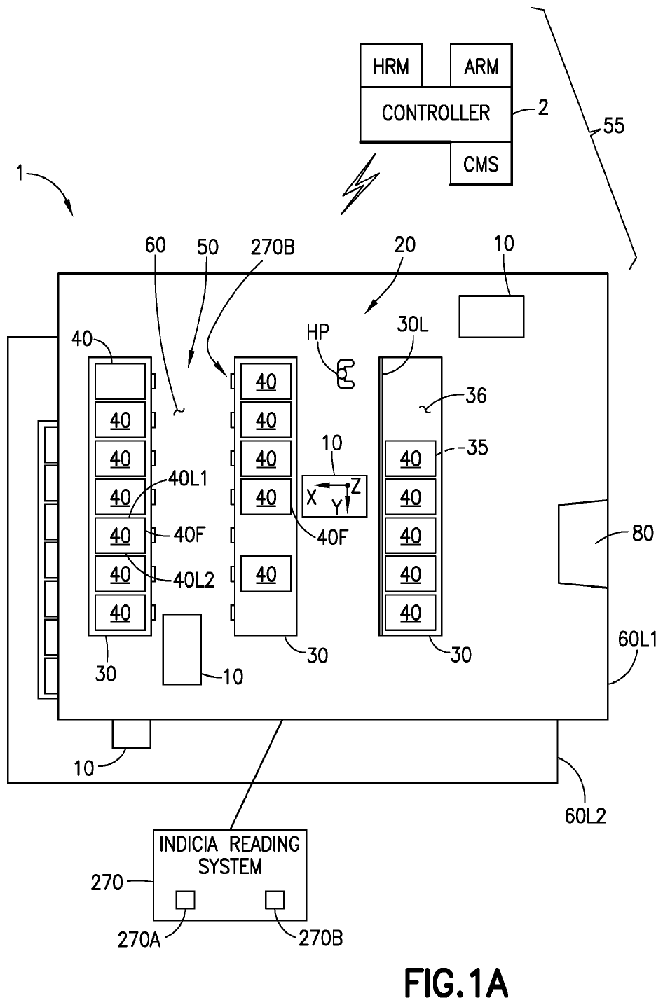

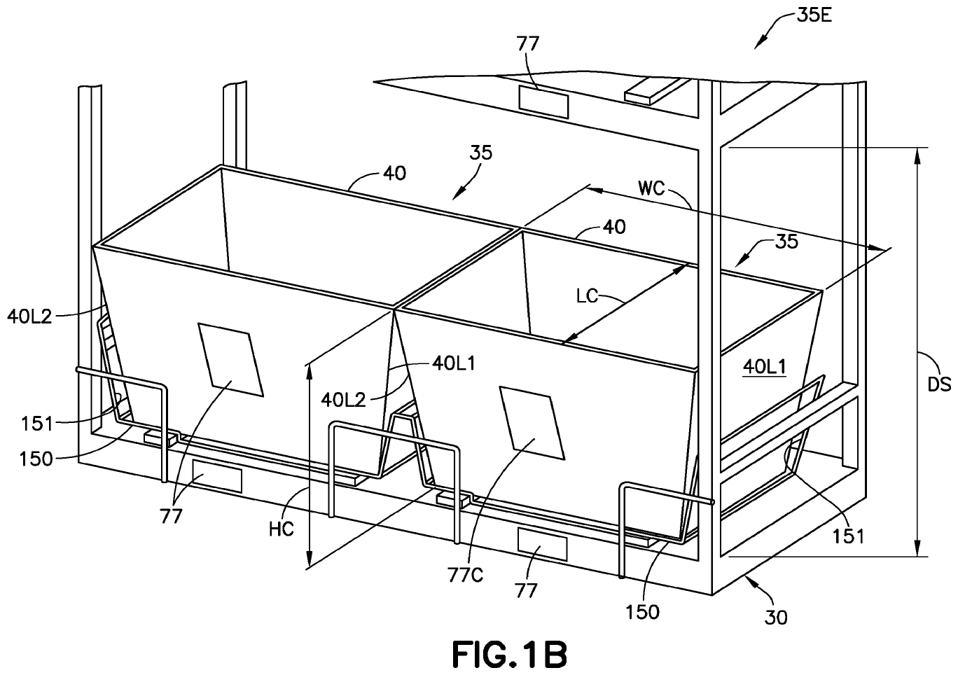

FIG. 1A is a schematic illustration of any suitable logistic or manufacturing/facility space 1 (e.g., distribution center, warehouse, manufacturing center etc.; referred to herein simply as a logistic/manufacturing space) in accordance with aspects of the present disclosure. Although the aspects of the present disclosure will be described with reference to the drawings, it should be understood that the aspects of the present disclosure can be embodied in many forms. In addition, any suitable size, shape or type of elements or materials could be used.

The aspects of the present disclosure provide for systems and methods for picking up a payload from, a bottom of the payload, with an autonomous mobile robot. The aspects of the present disclosure also provide for the picking mechanism and the payload thereon retracting into the autonomous mobile robot after picking the payload and for retracting the picking mechanism into the autonomous mobile robot after placing the payload. The aspects of the present disclosure provide for picking variously sized payloads made of any suitable material (e.g., plastic, cardboard, wood, etc.). For example, the variously sized payloads may be variously sized containers including but not limited to boxes, totes, crates, or other suitable containers (generally referred to herein as containers 40) that substantially lack features or structure that facilitates the automated grabbing/grasping of the containers.

Referring to FIGS. 1A and 1B, the aspects of the present disclosure may be employed in any suitable logistic/manufacturing space 1. The aspects of the present disclosure include an automated management system 55 that includes at least one array of container holding supports 30, one or more autonomous mobile robots 10, a vision system 270, and one or more controllers (e.g., such as a logistic/manufacturing space controller 2 and/or a controller system 258 of the autonomous mobile robot 10). Each array of container holding supports 30 includes container holding spaces 35 distributed in the logistic/manufacturing space 1. The arrays of container holding supports 30 are arranged so as to form aisles 50 (e.g., storage aisles) between the arrays of container holding supports 30 where predetermined container holding spaces 35 of the arrays of container holding supports 30 (and hence containers 40 held therein) are arranged along the aisles 50.

In one aspect, guiding inserts 150 may be disposed at respective container holding spaces 35 of the arrays of container holding supports 30. Here the guiding inserts 150 (that may be removably located or integral to the container holding support 30 structure) discriminate each container holding space 35 from another container holding space 35 and define at least one guide surface 151 configured to direct the container 40 held by an end effector 3000 of the autonomous mobile robot 10 into a predetermined discrete container holding space 35 on end effector 3000 placement of the container 40 into the predetermined discrete container holding space 35. The at least one guide surface 151 may be a planar contact surface (e.g., such as a planar wall) or a substantially line contact surface such as formed by a wire or rod that contacts the container 40 for guiding the container 40 into and locating the container 40 within the predetermined discrete container holding space 35. The guiding inserts 150 may serve to expand the pose envelope within which the autonomous mobile robot 10 aligns itself with the container holding space 35 for placing containers 40 and/or the location envelope of the containers 40 with respect to the manipulator system 260 so as to place containers in a container holding space 35 (or elevated container holding space 35E). In one aspect, the guiding inserts 150 provide for retention of the container 40 within the container holding space 35 so as to prevent movement of the container 40 after placement of the container 40. Retention of the container within the container holding space 35 effects a repeatable deterministic location of the containers 40 so as to increase accuracy of container placement (while at the same time decreasing alignment accuracy of the autonomous mobile robot 10 as described above) within the container holding space 35. In another aspect, the container holding spaces 35 includes no guides, where discrimination of discrete spaces is effected as described further below.

Referring again to FIG. 1A, the one or more autonomous mobile robots 10 may be substantially similar, except as described herein, to those described in United States provisional patent application No. 62/718,734 titled “Method and System for Automated Transport of Items” and filed on Aug. 14, 2018, the disclosure of which is incorporated herein by reference in its entirety. The one or more autonomous mobile robots 10 are configured (as described herein) to pick, place or otherwise move containers 40 (which hold or store any suitable products or goods and are configured for placement in the container holding spaces 35) from one place to another within the logistic/manufacturing space 1. The autonomous mobile robots 10 are deployed in the logistic/manufacturing space 1 to move throughout the logistic/manufacturing space 1 for moving the containers 40 according to instructions from any suitable controller, such as the logistic/manufacturing space controller 2. The logistic/manufacturing space controller 2 is in communication with the autonomous mobile robots 10 in any suitable manner (such as for example, through a wireless or wired communication connection). The autonomous mobile robots 10 are deployed on a single level 60L1 of the logistic/manufacturing space 1 or on multiple levels 60L1, 60L2 of the logistic/manufacturing space 1. The autonomous mobile robots 10 may travel between levels 60L1, 60L2 in any suitable manner (e.g., elevators, lifts, ramps, etc.) or be confined to a predetermined level 60L1, 60L2.

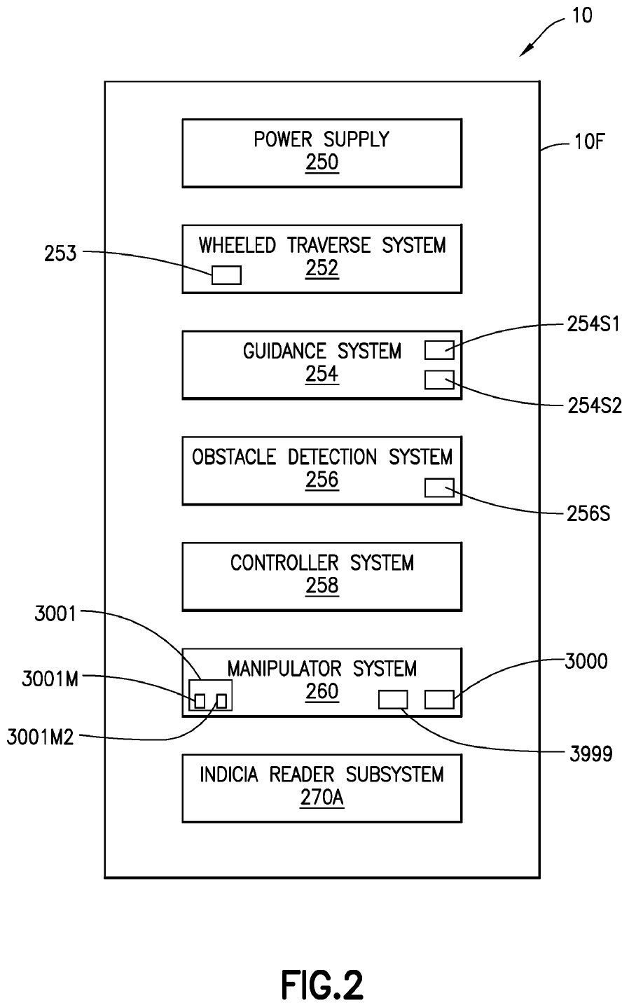

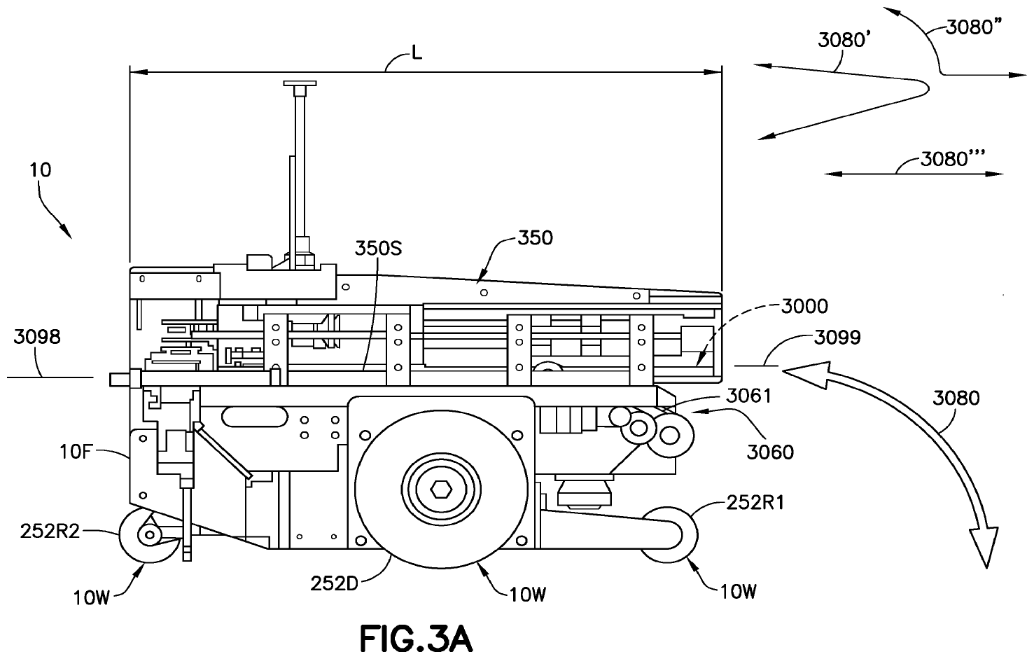

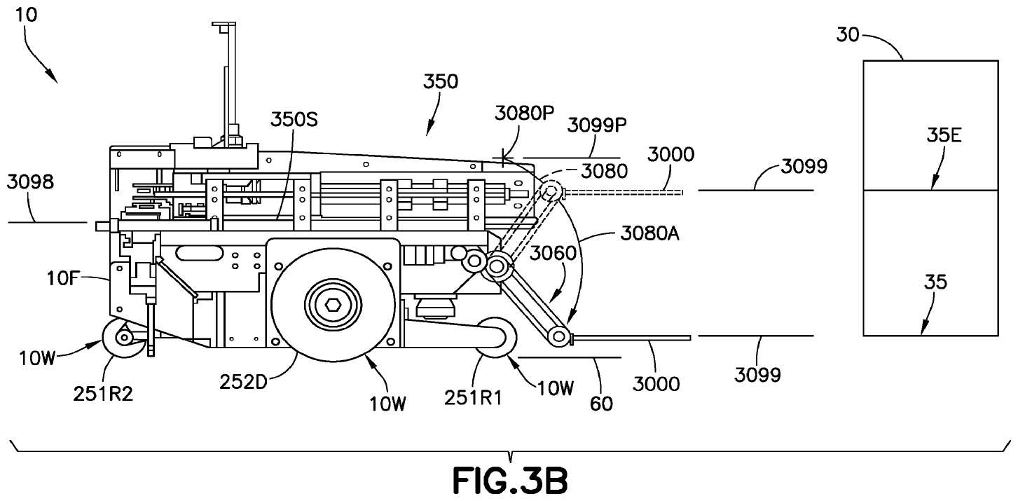

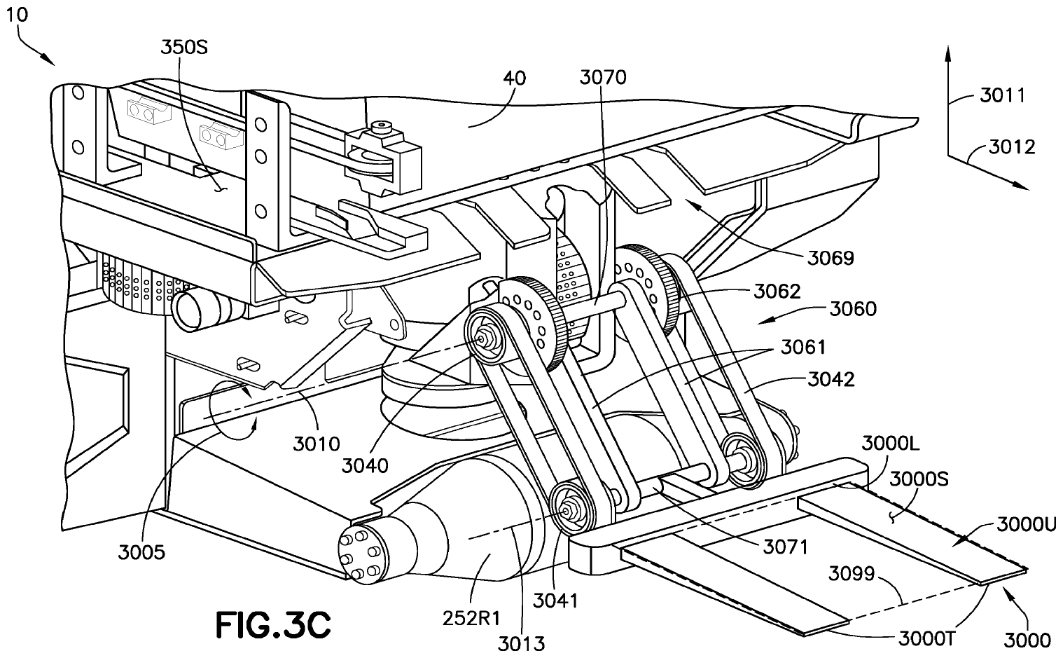

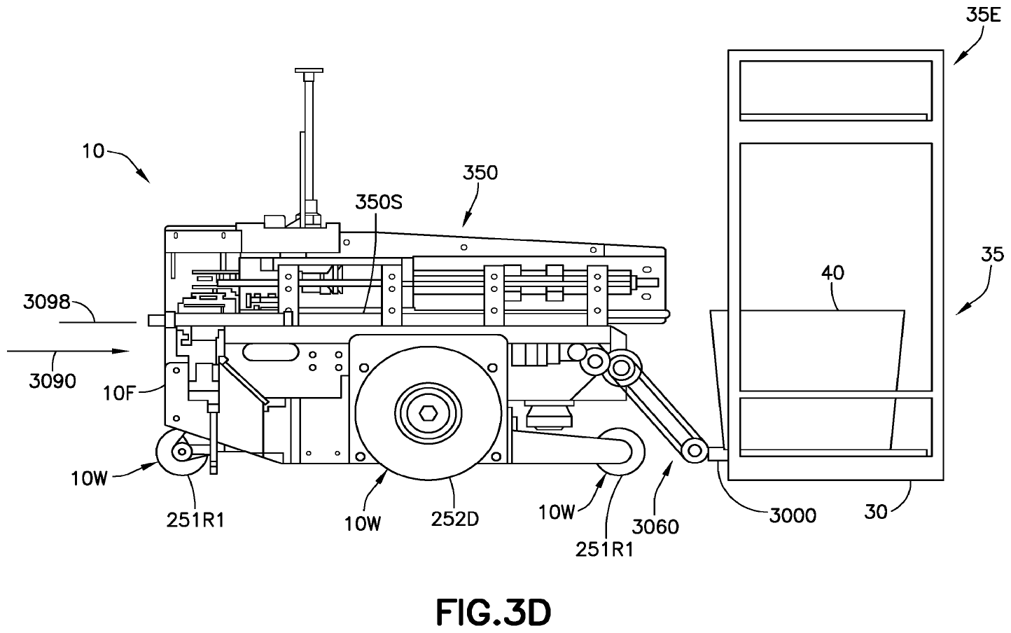

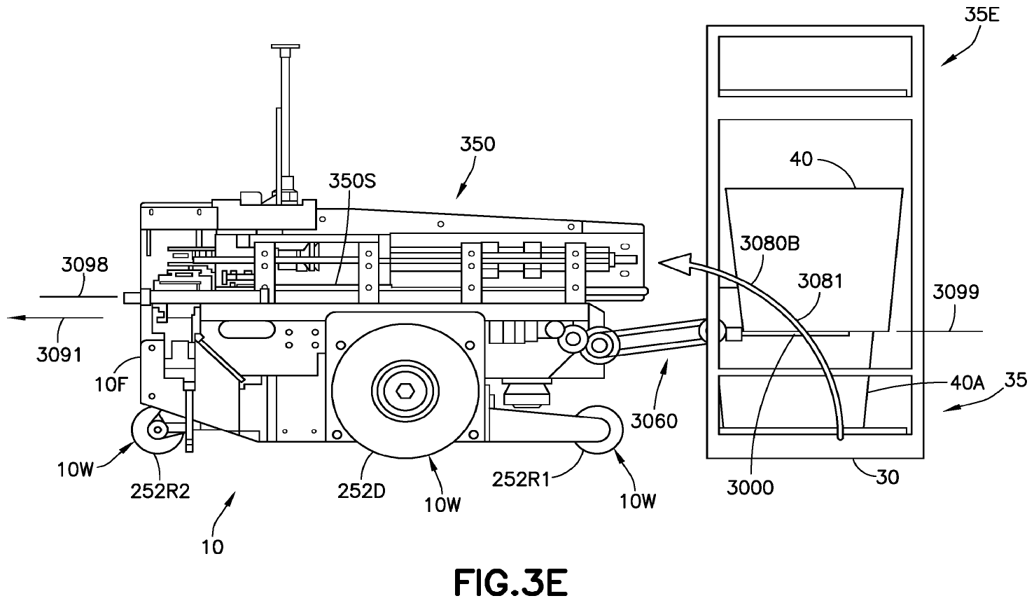

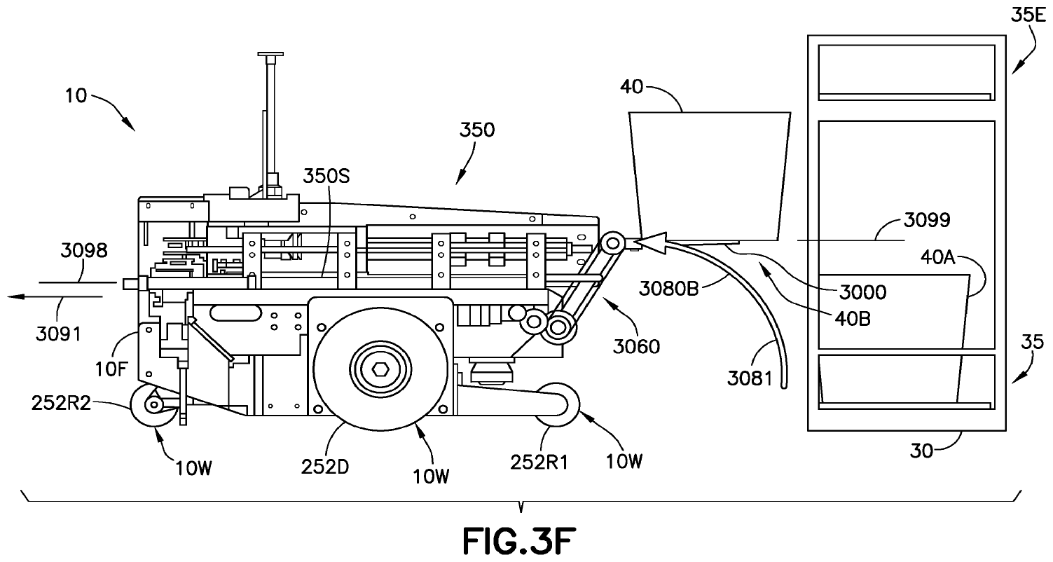

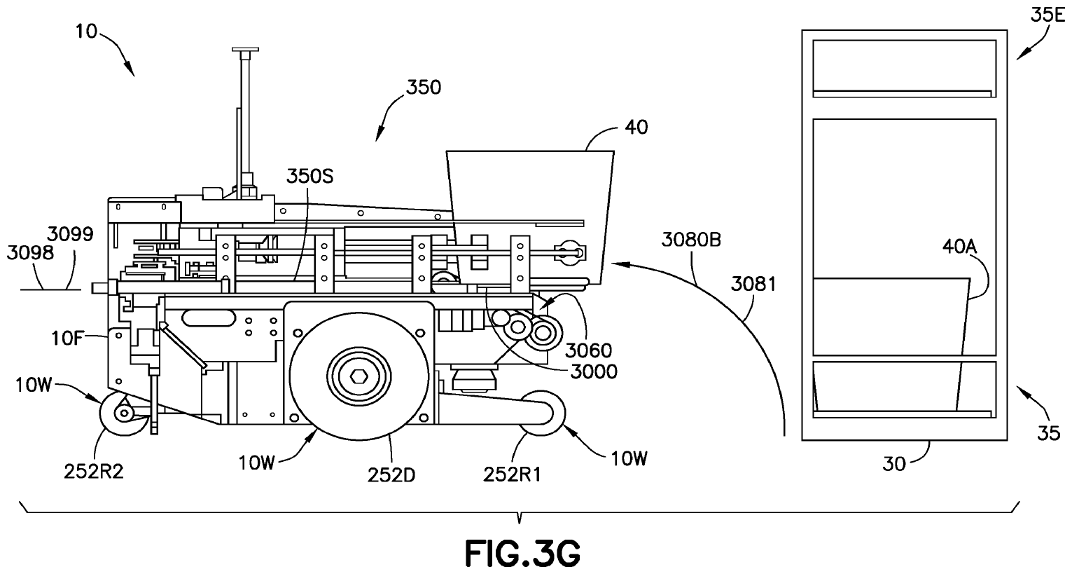

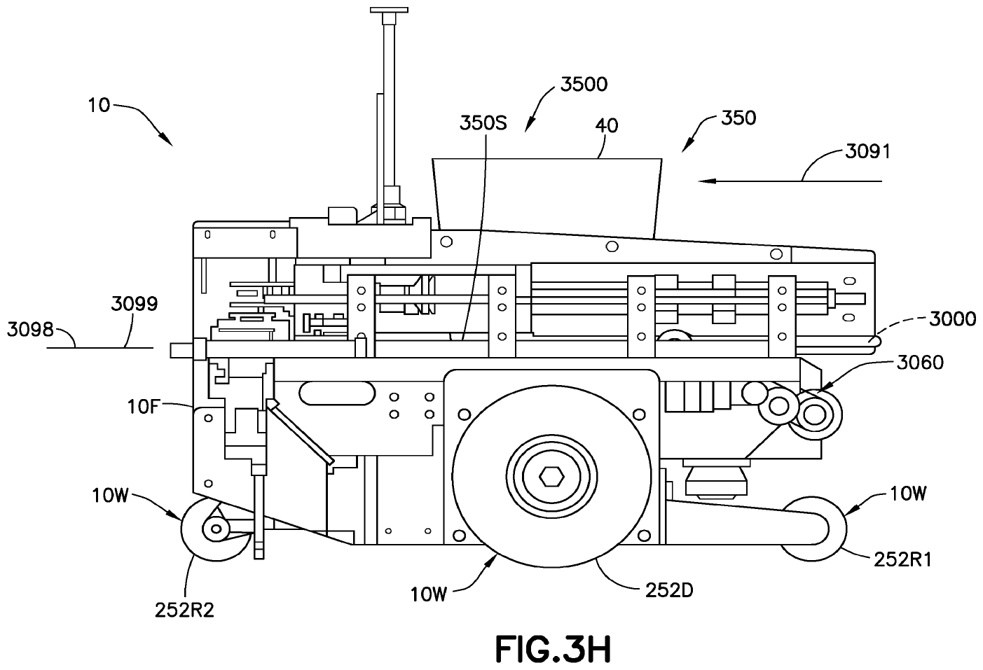

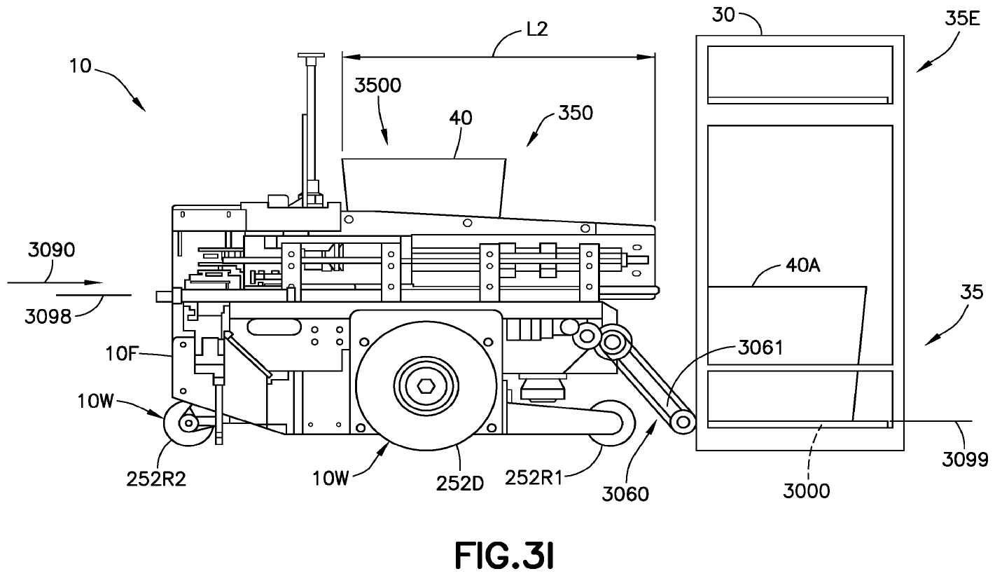

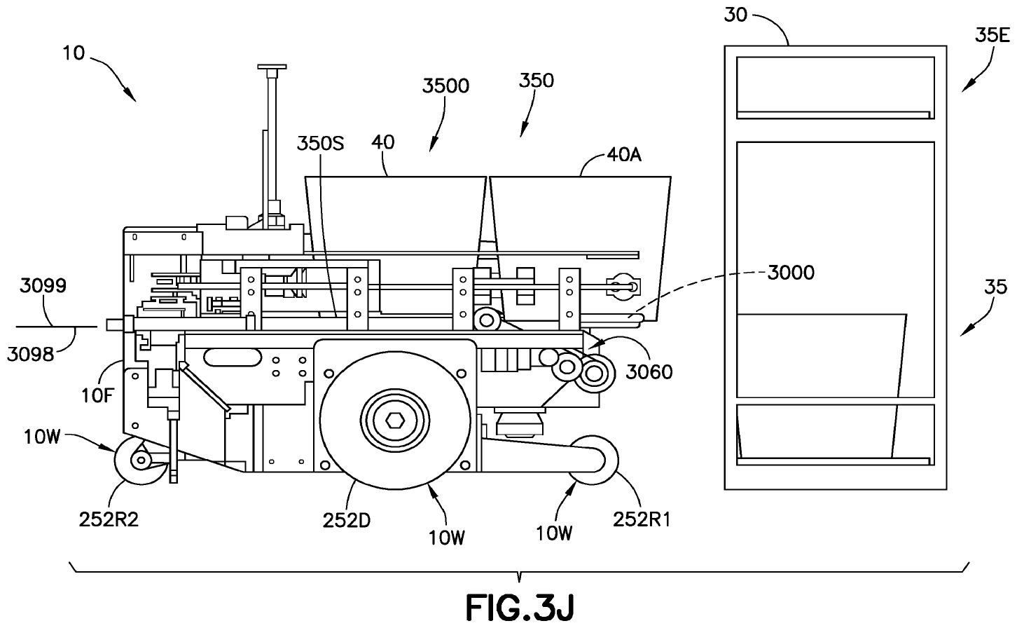

Referring to FIGS. 2 and 3A-3C, each autonomous mobile robot 10 includes a frame 10F, a power supply 250, a wheeled traverse system 252, a guidance system 254, an obstacle detection system 256, a controller system 258, a manipulator system 260 (that includes the end effector 3000), and a vision system subsystem 270A. The frame 10F defines a payload holding area 350 with a payload seating surface 350S (FIG. 3C). The wheeled traverse system 252 is dependent from the frame 10F for substantially free unrestricted roving of the autonomous mobile robot 10 on a riding surface 60 in the logistic/manufacturing space 1. For example, the wheeled traverse system 252 is mounted to the frame (and which includes a plurality of wheels 10W, at least one of which is a drive wheel 252D) for maneuvering the frame 10F (and hence the autonomous mobile robot 10) to effect the free unrestricted roving of the autonomous mobile robot 10 on the riding surface 60. In one aspect the wheeled traverse system 252 is a differential drive system having two independently operable coaxial drive wheels 252D and at least one roller wheel 252R1, 252R2 for balance or support of the frame 10F. The drive wheels 252D are driven together or independently by one or more motors and any suitable drive transmission controlled by, for example, the controller subsystem 258. In other aspects, the wheeled traverse system 252 includes steered wheels or any other suitable drive configuration for effecting movement of the autonomous mobile robot 10 through the logistic/manufacturing space 1.

The manipulator system 260 includes at least one drive section 3001 connected to the frame 10F, and having at least one motor 3001M defining at least one independent degree of freedom 3005 (FIG. 3C) which is illustrated as rotation about axis 3010 but in other aspects the at least one motor 3001M may include multiple motors that also provide degree of freedom movement along one or more of axes 3011, 3012 for providing additional degree of freedom movement to the end effector 3000. The manipulator system 260 also includes an articulated pick arm 3060 (also referred to herein as a swivel pick arm) dependent from the frame 10F. The articulated pick arm 3060 includes one or more rigid unarticulated members 3061 that are coupled to the frame at a first end for rotation about axis 3010. For example, shaft 3070 (or other suitable bearing member) may be fixed to the frame 10F and the first end of the one or more rigid unarticulated members 3061 may be rotatably mounted to the shaft 3070. The one or more rigid unarticulated members 3061 may be driven, at least for rotation about axis 3010, by the at least one motor 3001M in any suitable manner such as through a gear drive 3062 (where gear are non-rotatably fixed to the respective rigid unarticulated member so as to rotate with the respective rigid unarticulated member about the axis 3010) or any other suitable transmission.

The articulated pick arm 3060 also includes the end effector 3000 which is coupled to the one or more rigid unarticulated members 3061. For example, another shaft 3071 (or other bearing surface) may be rotatably coupled to the one or more rigid unarticulated members 3061 for rotation about axis 3013. The end effector 3000 is fixed to the shaft 3071 so as to rotate with the shaft 3071 about the axis 3013. In one aspect, the end effector 3000 may have a range of motion that spans from an elevation below a lowermost level of the payload seating surface 350S (as shown in FIG. 3B) onto the payload seating surface 350S (as shown in FIG. 3A). In another aspect, the range of motion of the end effector 3000 spans from an elevation above a level of the payload seating surface 350S (as shown in FIG. 3B (without a Z axis drive) and FIG. 3K (with a Z axis drive) such as when picking/placing containers 40 to an elevated container holding space 35E) onto the payload seating surface 350S. In one aspect, the arcuate path 3080 of the articulated arm elevates the end effector 3000 above the payload seating surface 350S along at least a portion of the arcuate path 3080 (see FIG. 3B) such that the arcuate path 3080 has an apex 3080P above the payload seating surface 350S. The end effector 3000 being disposed above the payload seating surface 350S provides for picking of containers 40 at elevated positions, such as elevated container holding space 35E, where the elevated position 35E may be any elevated position disposed within the span between a plane 3099P of the end effector 3000 at the apex 3080P and a lowermost position of the end effector 3000 (e.g., such as on or immediately adjacent the riding surface 60). As will be described below, in other aspects any suitable Z axis drive may be provided to provide additional pick elevation (e.g., along axis 3011) to the autonomous mobile robot 10.

The articulated pick arm 3060 is configured to transport the container 40 held by the end effector 3000 throughout the range of motion of the end effector 3000 with the container 40 leveled (e.g., aligned with a seating surface plane 3098 of the payload seating surface 350S so that the seating surface plane 3098 of the payload seating surface 350S and a seating surface plane 3099 of the end effector 3000 are substantially parallel with each other) with the payload seating surface 350S. In one aspect, the end effector 3000 is synchronized with respect to at least another part of the articulated pick arm 3060 so that the end effector holds the container 40 level so as to be aligned with the payload seating surface 350S (FIG. 3C) at each position of the end effector 3000 from the payload seating surface 350S throughout the range of motion of the end effector 3000. For example, one or more pulleys 3040 may be fixed to the shaft 3070 and are held stationary (so as not to rotate about axis 3010) by the shaft 3070. One or more other pulleys 3041 may be mounted to the shaft 3071 so as to rotate with the shaft 3071 and the end effector 3000 coupled thereto. The one or more pulleys 3040 are coupled to the one or more other pulleys 3041 by any suitable transmission 3042 (e.g., such as a chain, timing belt, etc.) so that the orientation of the end effector is slaved or timed relative to the payload seating surface 350S. For example, as the one or more rigid unarticulated members 3061 are rotated about axis 3010, the axis 3013 moves or swings along the arcuate path 3080 (FIG. 3A). As the axis 3013 moves the transmission 3042 between the one or more pulleys 3040 and the one or more other pulleys 3041 maintains a predetermined rotational orientation (e.g., the seating surface plane 3098 of the payload seating surface 350S and the seating surface plane 3099 of the end effector 3000 are substantially parallel with each other) of the end effector 3000 with the payload seating surface 340S.

As can be seen in FIG. 3A, the articulated pick arm 3060 is configured such that when retracted the seating surface plane 3099 of the end effector 3000 and the seating surface plane 3098 of the of the payload seating surface 350S may be substantially coplanar where the one or more rigid unarticulated members 3061 and the end effector 3000 are folded into the frame 10F. Referring also to FIG. 3C, the frame 10F may include apertures or slots 3069 that provide clearance for the one or more rigid unarticulated members 3061 to fold into the frame 10F through the payload seating surface 350S. In other aspects the articulated pick arm 3060 may have any suitable configuration for lifting a container 40 and retracting the articulated pick arm 3060 into a length L (FIG. 3A) of the autonomous mobile robot 10.

The end effector 3000 is configured so as to stably hold a container 40 therewith, and as described above, is operably connected to the at least one motor 3001M so that the at least one independent degree of freedom extends and retracts the articulated pick arm 3060 (e.g., at least along the arcuate path 3080), and raises and lowers the articulated pick arm (e.g., again, at least along the arcuate path 3080) defining the range of motion of the end effector 3000. In one aspect, the containers 40 have sides 40L1, 40L2 (illustrated as lateral sides but in other aspects front and back sides of the container 40 may be substantially similar to the lateral sides) that are grab free, and the end effector 3000 is an underpicking end effector 3000U, frictionally engaging with undersides or bottom 40B (FIG. 3F) of the container 40 so as to stably hold the container 40 for friction container transfer handling (e.g., the end effector does not have active or movable gripping members that move to grasp the container 40 such that the container 40 is held on the end effector by friction forces alone). In other aspects, the end effector may include active or movable gripping members. In one aspect, the end effector 3000 includes one or more tines 3000T that have respective seating surfaces 3000S that support (e.g., uphold the weight of) the container 40 and define the seating surface plane 3099 of the end effector 3000. While structure of the articulated pick arm 3060 and end effector 3000 are described above, it should be understood that in other aspects the articulated pick arm 3060 and/or end effector 3000 may have any suitable configuration for transferring containers 40 to and from the autonomous mobile robot 10 as described herein.

In one aspect, referring to FIGS. 2 and 3K, to effect container 40 transfer to the elevated container holding space 35E of the array of container holding supports 30, the at least one drive section 3001 has another motor 3001M2 defining another independent degree of freedom (such as along axis 3011, which may be referred to as a Z axis) for raising or lowering at least a portion 10FP of the autonomous mobile robot 10. In one aspect, the portion 10FP includes both the payload holding area 350 and the articulated pick arm 3060 so that the payload holding area 350 and the articulated pick arm 3060 are raised and lowered as a unit. In this aspect, any suitable lifting guide 3077 (e.g., linear guideways and bearings, scissor lift, ball screws and nuts, etc.) may be coupled to the other motor 3001M2 for moving the portion 10FP of the autonomous mobile robot 10 along axis 3011 (e.g., the Z direction) for raising and lowering at least the end effector 3000 so that the range of motion spans from the elevation above a level of the payload seating surface 350S onto the payload seating surface 350S. In other aspects, the portion 10FP of the autonomous mobile robot 10 includes the articulated pick arm 3060 such that the articulated pick arm 3060 is raised and lowered relative to the payload holding area 350. In other aspects, the entire autonomous mobile robot 10 may be raised or lowered by the other motor 3001M2. For example, any suitable lifting jacks 3078 may be coupled to the frame 10F and driven by the other motor 3001M2 for raising and lowering the frame 10F to effect container 40 transfer between the autonomous mobile robot 10 and the elevated container holding space 35E. In other aspects, the roller wheels 252R1, 252R2 may be pivotally coupled to the frame by respective pivot arms 3079 where the other motor 3001M2 rotatably drives the pivot arms 3079 to move the roller wheels 252R1, 252R2 towards and away from each other in respective directions 3014, 3015 for raising and lowering the frame 10F to effect container 40 transfer between the autonomous mobile robot 10 and the elevated container holding space 35E. In still other aspects, the frame 10F or the portion 10FP of the frame 10F may be raised and lowered in any suitable manner to effect raising and lowering the frame 10F or the portion 10FP of the frame 10F to effect container 40 transfer between the autonomous mobile robot 10 and the elevated container holding space 35E. As may be realized, the other motor 3001M2 may be employed with the motor 3001M to provide increased range of motion (e.g., two degree of freedom motion) to the articulated pick arm 3060 by raising or lowering the apex 3080P of the arcuate path 3080 along axis 3011.

In one aspect, referring to FIGS. 2 and 3E-3J, the articulated pick arm 3060 is decoupled from the payload seating surface 350S, so as to handoff the container 40, held and transported by the end effector 3000, from the end effector 3000 onto the payload seating surface 350S, and pick another container 40A with the end effector 3000 within the range of motion of the end effector 3000 with the container 40 in the payload holding area 350. For example, the manipulator system 260 may include any suitable handoff mechanism 3999 that is configured to transfer the container 40 between the end effector 3000 and a predetermined buffer location 3500 of the payload holding area 350 by moving the container in direction 3091 off of the end effector 3000 (or a location of the payload seating surface 350S disposed above the end effector 300 when the end effector is in the retracted configuration) and onto a portion of the payload seating surface 350S that defines the predetermined buffer location 3500. While the aspects of the present disclosure show a single container 40 being buffered, in other aspects any suitable number of containers may be buffered on the payload seating surface 350S.

In one aspect, referring to FIGS. 2-8, (noting the articulated pick arm 3060 is not illustrated in detail in FIG. 3 for clarity of the description) the handoff mechanism 3999 may include a friction case transfer mechanism 367. Referring particularly to 2 and 4-8, the friction case transfer mechanism 367 includes, in one aspect, actuable gripping members 370, 371 that pivot about respective axes Z1, Z2 to grip sides 40L1, 40L2 of a container 40 held by the end effector 3000 or disposed on the portion of the payload seating surface 350S above the end effector 3000. The actuable gripping members 370, 371 may be coupled to rails 321 and be driven by any suitable gripping member drive 312 of the manipulator system 260 so as to move in the X direction. In this aspect, the end effector 3000 may extend to frictionally grip the container 40 and retract towards the payload holding area 350 to expose the sides 40L1, 40L2 of the container 40 to the actuable gripping members 370. The actuable gripping members 370, 371 may pivot about the respective axes Z1, Z2 so as to grip the exposed sides 40L1, 40L2 to at least in part transfer the container 40 into the predetermined buffer location 3500 (e.g., so that the container 40 is transferred between the end effector 3000 and the predetermined buffer location 3500.

In one aspect, the actuable gripping members 370, 371 may be biased about the respect axes Z1, Z2 so that a free end 370E, 371E is biased outward to increase a distance between the free ends 370E, 371E when the actuable gripping members 370, 371 extend to grip the container 40 held on the end effector 3000. The frame 10F may include any suitable cam surface(s) 397 that engage the respective actuable gripping members 370, 371 as the actuable gripping members 370, 371 are retracted into the predetermined buffer location 3500. The cam surfaces 397 engage the respective actuable gripping members 370, 371 so as to pivot the free ends 370E, 371E towards the centerline 399 of the payload holding area 350 to decrease the distance 396 between the free ends 370E, 371E and grip the sides 40L1, 40L2 of the container 40. In other aspects, any suitable drive may be provided to pivot the actuable gripping members 370, 371 about the respective axes Z1, Z2.

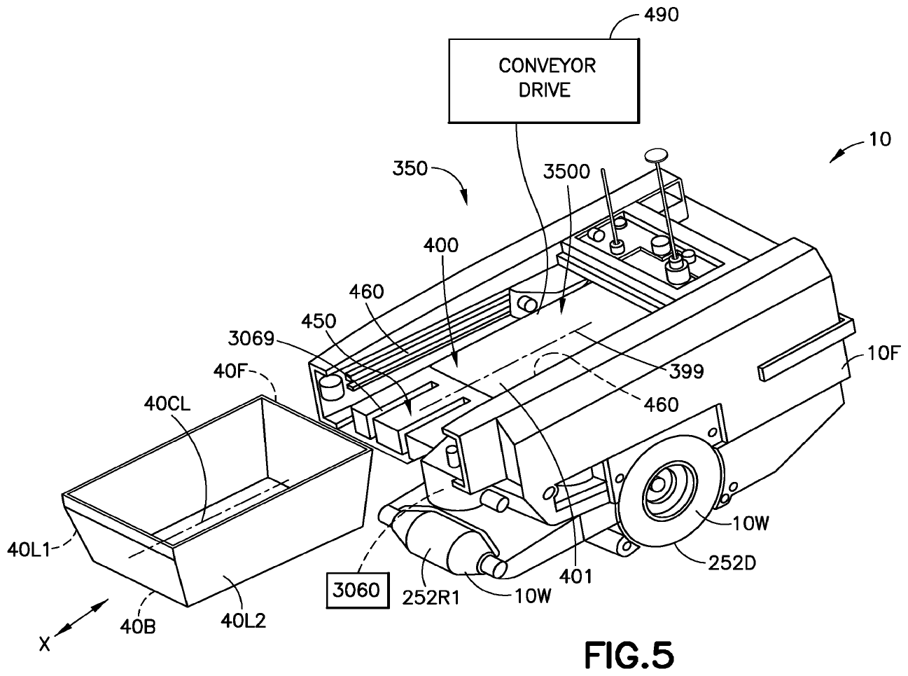

The actuable gripping members 370, 371 may effect placement of the container 40 at a predetermined lateral position relative to, for example, the centerline 399 of the payload holding area 350. Locating the container 40 at the predetermined lateral position (e.g., such that a longitudinal centerline 40CL (FIG. 5) of the container 40 is substantially aligned with the longitudinal centerline 399 of the payload holding area 350) locates the container 40 relative to the autonomous mobile robot 10 so that the container 40 can be placed at a predetermined container holding space 35 in a known/predetermined location (e.g., to place the containers 40 in respective container holding spaces 35 in a tightly packed storage density as shown in FIG. 1B—where tightly packed storage density refers to placement of containers 40 adjacent one another so that the sides 40L1, 40L2 of the adjacent containers 40 have a minimal clearance between them or are substantially touching one another but can be inserted or removed from the array of container holding supports 30 without disturbing a support position adjacent containers). In one aspect, the placement envelope of the container 40 with respect to the autonomous mobile robot 10, and/or the end effector 3000, may be relaxed such as when the container 40 is positioned within the container holding space 35 by the guiding inserts 150 (as previously described).

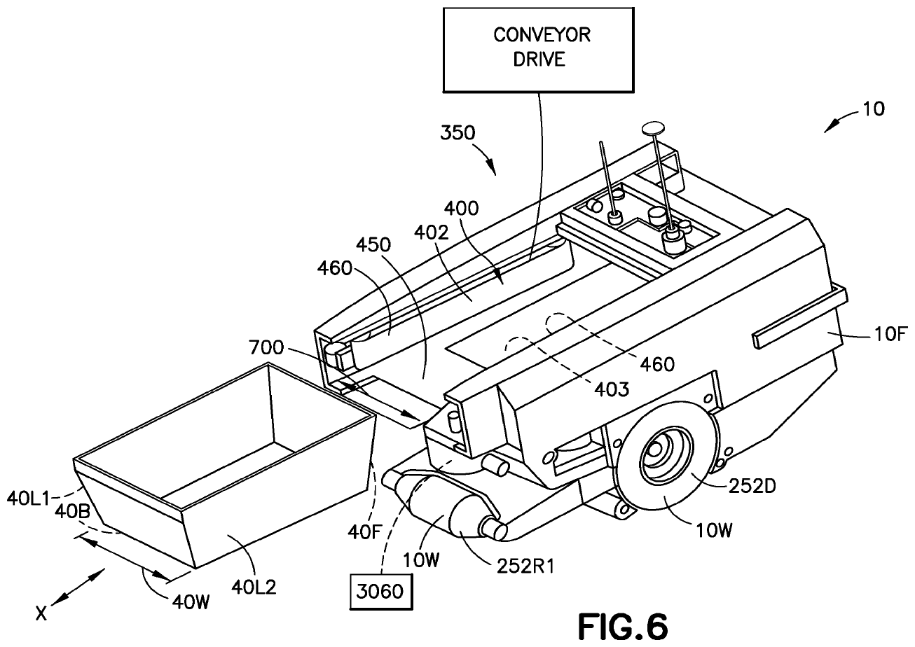

In another aspect, referring to FIGS. 5-8, the friction case transfer mechanism 367 includes at least one conveyor 400 disposed on one or more of a payload holding area bed 450 and a payload area lateral side 460. In one aspect, the at least one conveyor 400 may be employed with the actuable gripping members 370, 371; while in other aspects the at least one conveyor 400 may be employed without the actuable gripping members 370, 371. Referring to FIGS. 5 and 6, in one aspect, the at least one conveyor 400 is a conveyor belt 401 that forms at least a portion of the payload holding area bed 450. The conveyor belt 401 is driven in any suitable manner by any suitable conveyor drive 490 of the manipulator system 260. In another aspect, the at least one conveyor 400 includes conveyor belts 402, 403 that are disposed on respective lateral sides 460 of the payload holding area 350. The conveyor belts 402, 403 may be driven by the conveyor drive 490 in any suitable manner. In another aspect, the friction case transfer mechanism 367 includes the conveyor belt 401 and the conveyors belts 402, 403. In this aspect, the end effector 3000 may extend to frictionally grip the container 40 and retract towards the payload holding area 350. As the container 40 is retracted into the payload holding area 350 by the end effector 3000, one or more of the sides 40L1, 40L2 and the bottom 40B of the container engage(s) one or more of the respective conveyor belts 401, 402, 403 (where the conveyor belt 401 is provided the bottom 40B of the container engages the conveyor belt 401; where the conveyors belts 402, 403 are provided the sides 40L1, 40L2 engage the respect conveyor belts 402, 403; where the conveyor belts 401, 402, 403 are provided the bottom 40B and sides 40L1, 40L2 engage the respective conveyor belts 401, 402, 403), where, one or more of the conveyor belts 401, 402, 403 at least in part transfer the container 40 to the predetermined buffer location 3500 (see also FIGS. 3A and 3J).

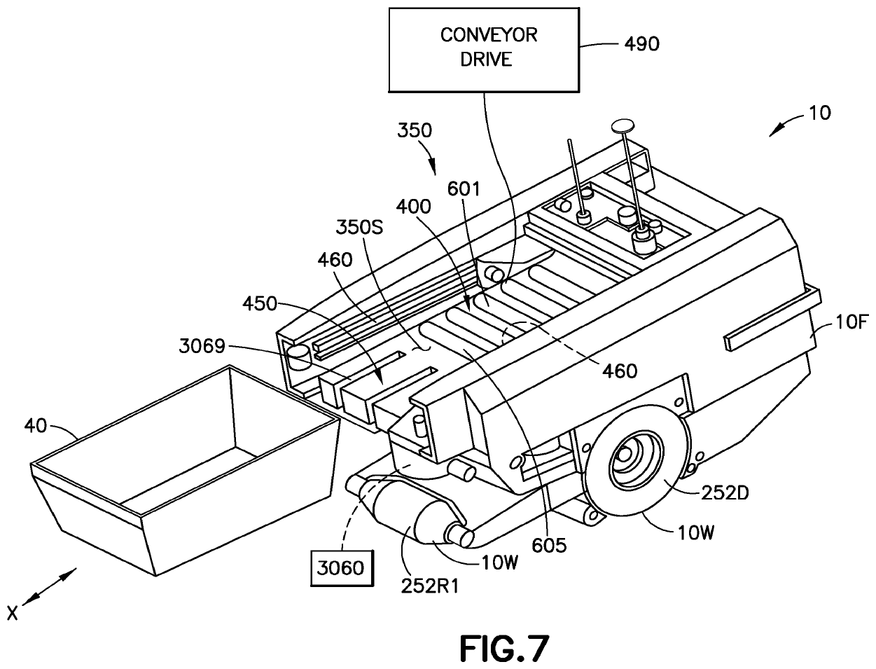

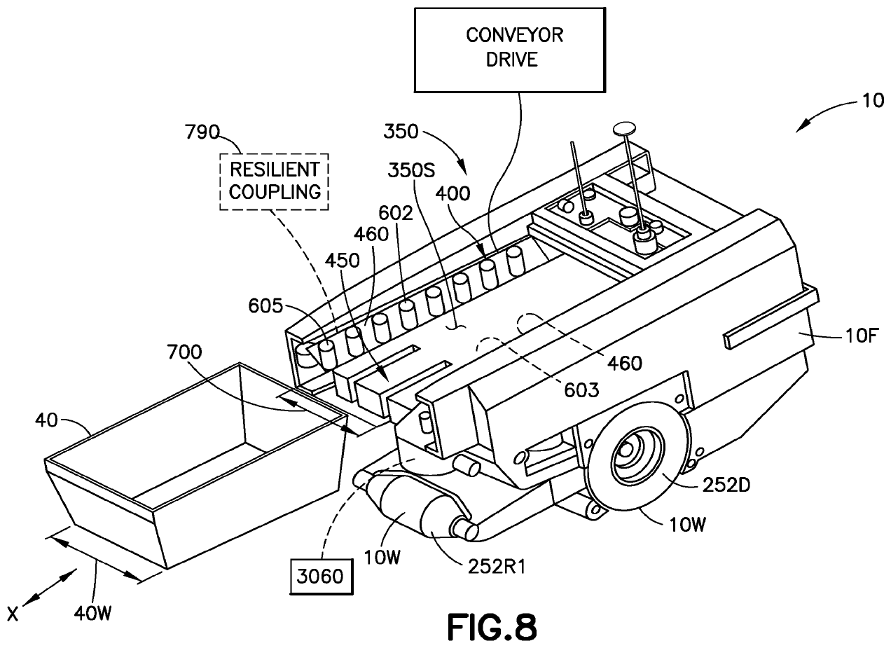

Referring to FIGS. 7 and 8, in one aspect, the at least one conveyor 400 is a roller conveyor 601 that forms at least a portion of the payload holding area bed 450. The roller conveyor 601 is driven in any suitable manner by the conveyor drive 490 of the manipulator system 260. In another aspect, the at least one conveyor 400 includes roller conveyors 602, 603 that are disposed on respective lateral sides 460 of the payload holding area 350. The roller conveyors 602, 603 may be driven by the conveyor drive 490 in any suitable manner. In another aspect, the friction case transfer mechanism 367 includes the roller conveyor 601 and the roller conveyors 602, 603. In this aspect, the end effector 3000 may extend to frictionally grip the container 40 from underneath the container 40 and retract towards the payload holding area 350. As the container 40 is retracted into the payload holding area 350 by the end effector 3000, one or more of the sides 40L1, 40L2 and the bottom 40B of the container engage(s) one or more of the respective roller conveyors 601, 602, 603 (where the roller conveyor 601 is provided the bottom 40B of the container engages the roller conveyor 601; where the roller conveyors 602, 603 are provided the sides 40L1, 40L2 engage the respect roller conveyors 602, 603; where the roller conveyors 601, 602, 603 are provided the bottom 40B and sides 40L1, 40L2 engage the respective roller conveyors 601, 602, 603), where one or more of the roller conveyors 600, 601, 602 at least in part transfer the container 40 between the predetermined buffer location 3500 and the end effector 3000 or a portion of the payload seating surface 350S disposed above the end effector 3000. Each of the roller conveyors 601, 602, 603 includes one or more rollers 605 that is/are rotatably driven by the conveyor drive 490 for transferring the container 40 to and from the payload holding area 350.

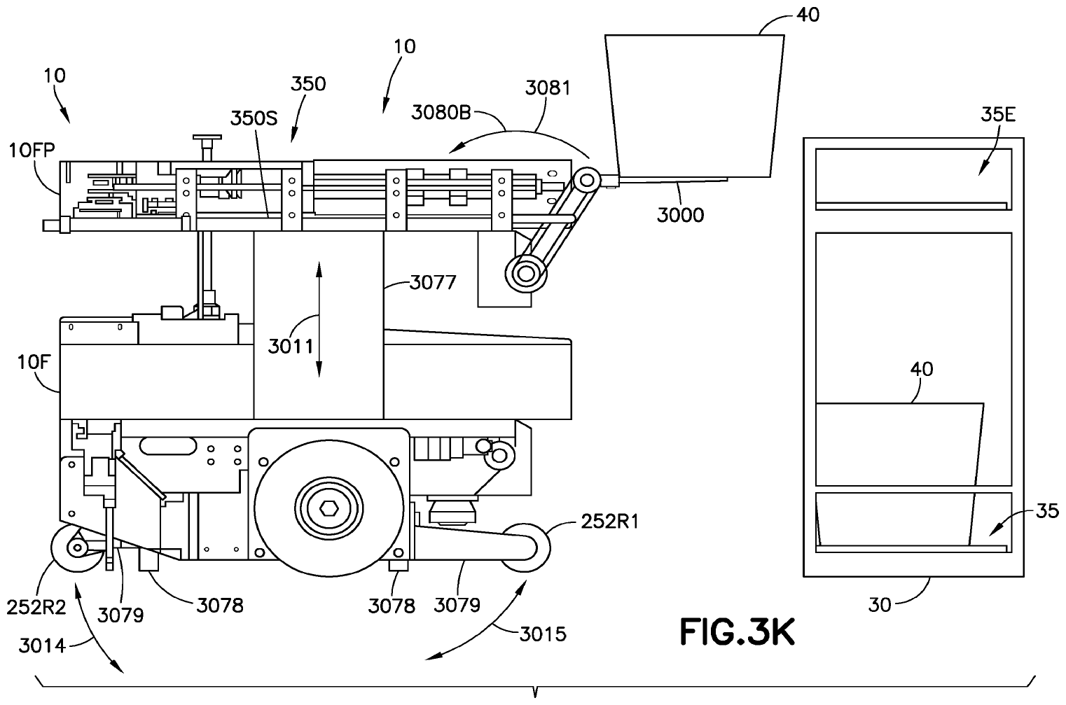

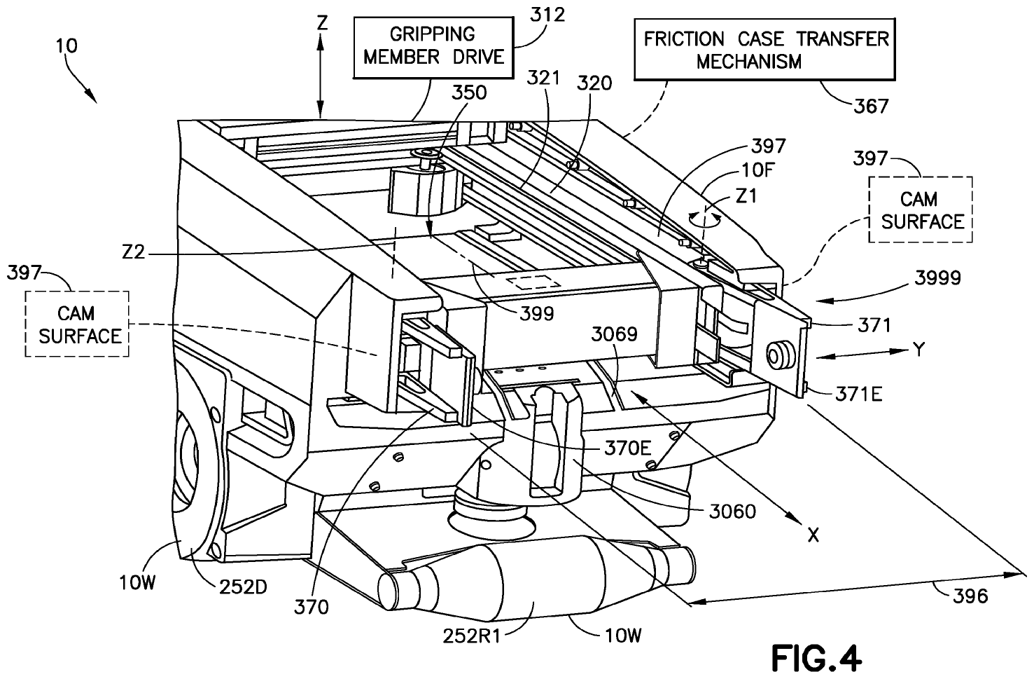

The conveyor belts 402, 403 and/or the roller conveyors 602, 603 may be coupled to the frame 10F by any suitable resilient coupling 790 that biases the conveyor belts 402, 403 or the roller conveyors 602, 603 in the Y direction towards the centerline 399 (FIG. 4) of the payload holding area 350 so that a distance 700 (FIGS. 6 and 8) between the opposing conveyor belts 401, 402 or opposing roller conveyors 602, 603 is less than a lateral width 40W (FIGS. 6 and 8) of the container 40 so that the conveyor belts 402, 403 and the roller conveyors 602, 603 positively engage the sides 40L1, 40L2 of the container 40 and can accommodate containers 40 having differing lateral widths 40W. The resilient coupling 790 may include springs, resilient foams, and/or other biasing members that bias the opposing conveyor belts 402, 403 and opposing roller conveyors 602, 603 towards each other. The distance 700 between the opposing conveyor belts 402, 403 and opposing roller conveyors 602, 603 may be adjusted (e.g., to allow insertion of the container 40 between the opposing conveyor belts 402, 403 and opposing roller conveyors 602, 603) depending on the lateral width 40W of the containers 40 to be transferred by the autonomous mobile robot 10. Where the conveyor belt 401 or roller bed 601 is/are employed as the payload holding area bed 450 the autonomous mobile robot 10 may transfer containers having any suitable lateral widths 40W (e.g., containers 40 with varying lateral widths 40W may be transferred substantially without any lateral adjustments to the autonomous mobile robot 10—the manipulator system 260 (FIG. 2) dynamically and automatically adjusts for various size containers). As may be realized, a gripping surface (such as the bottom 40B) of the container 40 is larger than support area formed by the end effector 3000.

In other aspects, any suitable conveyance/gripper may be included in or adjacent the payload holding area 350 of the autonomous mobile robot 10 to transfer containers 40 to and from the predetermined buffer location 3500. For example, the autonomous mobile robot 10 may include a vacuum gripper such as disclosed in United States provisional patent application No. 62/718,734 titled “Method and System for Automated Transport of Items” and filed on Aug. 14, 2018, the disclosure of which is incorporated herein by reference in its entirety.

Referring again to FIGS. 1A and 2, the power supply 250 is any suitable power supply, such as a rechargeable power supply, configured to provide power to the autonomous mobile robot 10 and all of its systems/subsystems 252, 254, 256, 258, 260, 270A. The controller system 258 is any suitable control system such as a microprocessor-based controller subsystem configured to control operation of the autonomous mobile robot 10 in performing programmed behaviors such as those described herein. The controller subsystem 258 is configured (e.g., programmed) to perform various functions, including effecting the transport of items with the autonomous mobile robot 10 between transport path endpoints, positioning the autonomous mobile robot 10 (as described herein) so as to transfer a container between a predetermined container holding space and the autonomous mobile robot 10 with the range of motion of the end effector, and coordinating movement (as described herein) of the end effector 3000 of the articulated pick arm 3060 with movement of the wheeled traverse system 252 to effect transfer of containers 40 to and from the payload holding area 350. The controller system 258 is connected to and may be responsive to the output of one or more of the guidance subsystem 254, the output of obstacle detection subsystem 256, and the output of the vision system subsystem 270A. The controller system 258 controls the wheeled traverse system 252 to maneuver the autonomous mobile robot 10 (as described herein) to prescribed travel path endpoint locations such as one or more predetermined container holding spaces 35 and an order filling station 80 (FIG. 1A). The controller system 258 is also connected to the manipulator system 260 (of which the end effector 3000 is a part of) such that the manipulator system 260 is commanded by the controller system 258 to pick or place a container 40 with the end effector 3000 from any suitable container holding location.

The controller system 258 is connected to the logistic/manufacturing space controller 2 in any suitable manner such as through a wired or wireless connection for receiving storage container picking/placing and transport commands from the logistic/manufacturing space controller 2. For example, in one aspect the logistic/manufacturing space controller 2 includes customer management system CMS configured to receive instructions to identify containers 40 (that include products associated with the containers) and the corresponding container holding spaces 35 for the identified containers 40. In one aspect, the customer management system CMS may be warehouse management system or be coupled to a warehouse management system in any suitable manner (e.g., wired or wirelessly). In one aspect, the warehouse management system may be remotely located from the customer management system CMS. In one aspect the logistic/manufacturing space controller 2 also includes, or is otherwise connected to, an autonomous mobile robot manager ARM that is configured to command the autonomous mobile robots 10 so that the autonomous mobile robots 10 traverse the riding surface 60, of the respective level 60L1, 60L2, to the corresponding container holding spaces 35 for picking at least one of the identified containers 40. In one aspect, the autonomous mobile robot manager ARM is in communication with the autonomous mobile robots 10 in any suitable manner, such as a wired or wireless connection. In one aspect, the logistic/manufacturing space controller 2 also includes, or is otherwise connected to, an automated picker manager HPM (which may be located remote from the logistic/manufacturing space controller 2) that is communicably connected with at least one picker. In one aspect, the picker may be a human picker HP (FIG. 1A) or any other suitable picker (autonomous, remote controlled, etc.). The automated picker manager HPM is in communication with the autonomous mobile robot manager ARM and is configured to command the at least one human picker HP to work in concert with the at least one autonomous mobile robot 10 in any suitable manner such as described in, for example, U.S. provisional patent application No. 62/063,825 filed on Oct. 14, 2014 and entitled “Storage Material Handling System”, the disclosure of which is incorporated herein by reference in its entirety.

Referring to FIGS. 1A and 2, one or more of the robot 10 systems include sensors, as will be described below, that provide the autonomous mobile robot awareness of (e.g. the ability to detect) the environment around the autonomous mobile robot 10 so that the autonomous mobile robot knows its position and orientation with respect to the logistic/manufacturing space 1 substantially at all times. For example, the autonomous mobile robots 10 know their surroundings at a time where the autonomous mobile robots receive a command from, for example, the logistic/manufacturing space controller 2 for picking and transporting a container 40 and prior to navigating. Based on the awareness of its surroundings the autonomous mobile robot 10 selects a path through the logistic/manufacturing space 1 based on any suitable optimizing algorithm resident in, for example, controller system 258 of the autonomous mobile robot 10 and then iteratively updates the path (e.g. the path is changed from the selected path as needed) based on, for example, information obtained from the autonomous mobile robot sensors and any detected obstacles, transients and waypoints, such as in a manner described in U.S. patent application Ser. No. 14/972,722 filed on Dec. 17, 2015 entitled “Method and System for Automated Transport of Items”, the disclosure of which is incorporated herein in its entirety.

As may be realized, the sensors provide alignment (as will be described herein) between the autonomous mobile robots 10 and the containers 40 and/or container holding spaces 35 to or from which a container 40 is picked or placed. The sensors also prevent the autonomous mobile robot 10 from colliding with other autonomous mobile robots 10, warehouse equipment (e.g. such as racks, forklifts, etc.), humans or other obstacles. As may be realized, although humans are not required to be in the aisles 50 while the autonomous mobile robots 10 are moving containers 40 within the aisles 50 and other portions of the logistic/manufacturing space 1, the aspects of the disclosed embodiment do not restrict human access within zones of movement of the autonomous mobile robots 10 during operation of the autonomous mobile robots 10. The fully autonomous nature of the autonomous mobile robots 10 does not require substantially any mechanical structure to contain the autonomous mobile robots or in other words, the operation of the autonomous mobile robots 10 does not hinder human access to the storage spaces and vice versa (the autonomous mobile robots comingle with humans in a common space of the automated storage system).

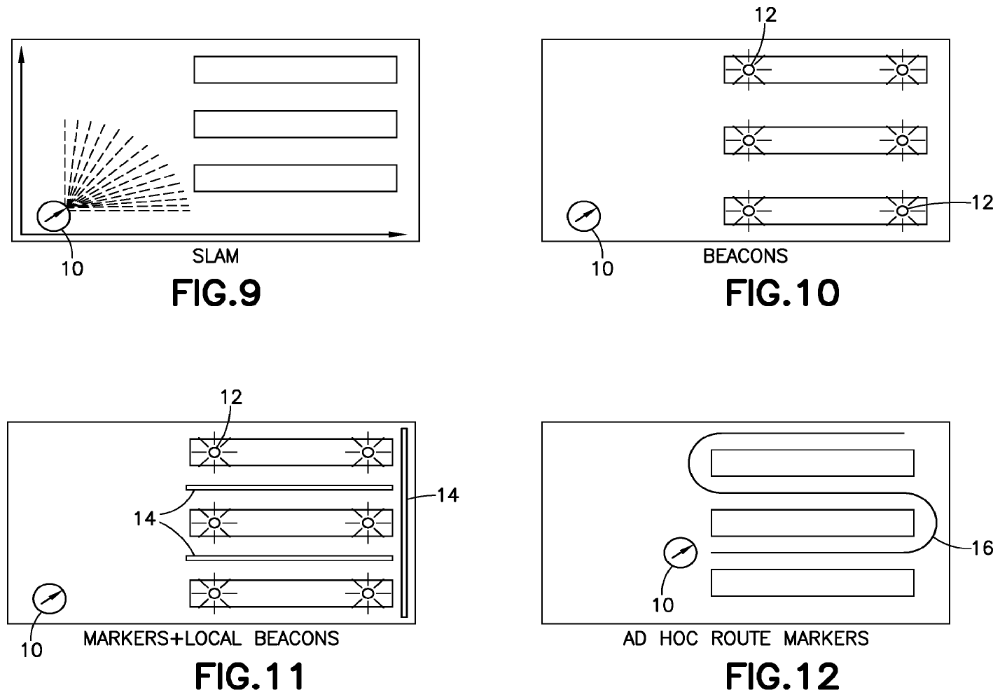

Still referring to FIGS. 1A and 2, the guidance system 254 is mounted to the frame 10F of the autonomous mobile robot 10 for interacting with the wheeled traverse system 252 and is configured to effect navigation of the autonomous mobile robot 10 in any suitable manner such as those described in U.S. Pat. No. 8,676,425 and U.S. patent application Ser. No. 13/285,511 filed on Oct. 31, 2011 the disclosures of which are incorporated herein by reference in their entireties. Referring also to FIG. 9, in one aspect the guidance subsystem includes a simultaneous location and mapping (SLAM) navigation system that provides the autonomous mobile robot 10 a global coordinate or reference frame REF with respect to the logistic/manufacturing space 1. Here the autonomous mobile robot guidance is effected through a coordinate system that lacks physical markers or beacons.

Referring also to FIGS. 10-12, in one aspect, the guidance system 254 includes one or more of a marker detecting sensor(s) 254S1 (FIG. 2) and/or a beacon sensor(s) 254S2 (FIG. 2). In one aspect the marker detecting sensor(s) 254S1 are configured to detect the position of a marker (such as a capacitive or inductive marker or other optical marker including but not limited to barcodes) laid on the riding surface 60 (e.g. which may be an undeterministic traverse surface) and/or on any other suitable surface such as the walls of the logistic/manufacturing space 1 and/or on the array of container holding support(s) 30. In one aspect the marker detecting sensor(s) 254S2 include one or more of a photodiode-based sensor, one or more radiation sources (e.g., LEDs), inductive sensors, capacitive sensors, barcode reader, etc. to detect the marker. In one aspect the beacon sensor 254S2 includes any suitable transmitter and/or receiver configured to actively or passively detect any suitable radio frequency beacons (or other suitable beacon such as an infrared, laser or other optical beacon) in, for example, a manner described in U.S. patent application Ser. No. 14/972,722, previously incorporated by reference herein. As can be seen in FIG. 10, for example, the guidance subsystem 254 includes a plurality of active (e.g. having a radio frequency or other (e.g., infrared) beacon transmitter) or passive (e.g. configured to passively return a signal) beacons or tags (referred to herein as beacons 12) that are located at any suitable location of the logistic/manufacturing space 1 (such as on the racks, on walls, on the riding surface 60, ceiling, etc.). In this case, the beacon sensor(s) 254S2 are configured to detect signals from beacons or detect the beacons themselves for locating the autonomous mobile robot 10 relative to the container holding spaces 35, the array of container holding supports 30, the order filling stations 80 and any other suitable structure of the logistic/manufacturing space 1. By way of example, where beacons 12 are used, each autonomous mobile robot 10 should secure a line of sight to one or more beacons 12, for example, an origin and/or destination beacon could be visible (either optically or through radio waves) to the autonomous mobile robot 10 for at least a period of time. The autonomous mobile robot 10 moves directly from one beacon (e.g. the origin beacon) toward the other (e.g. the destination beacon) unless an obstacle intervenes as described herein. In one aspect each beacon 12 establishes a respective coordinate system, where the beacon is the origin of the respective coordinate system. Angular encoding (or any other suitable encoding) is employed to specify the axes of the beacon coordinate system. The beacon coordinate system enables robots to queue along a particular ray whose origin is the beacon. Angle encoding can also enable other useful properties.

Referring to FIG. 11, in one aspect, the guidance system 254 includes shorter range active or passive beacons 12 (which are substantially similar to those described above) and pathways established by any suitable markers 14 (such as those described above) attached to other suitable surface (e.g. walls, racks, etc.) so that the autonomous mobile robots are provided with a rough global reference frame. Here the beacon 12 and marker 14 arrangement simplifies sensor range requirements compared to SLAM navigation. Referring also to FIG. 12 the guidance subsystem 254 includes, in one aspect, an ad hoc marker system including one or more markers 16 laid on other suitable surface (e.g. walls, racks, etc.), in some cases temporarily. A route marker 14 indicating an autonomous mobile robot 10 path is employed in situations where either a line of sight between beacons does not exist or traveling in a straight path between beacons is not desired. For example, a route marker enables an autonomous mobile robot 10 to avoid a ditch at a construction site.

In one aspect, referring also to FIG. 2 the controller system 258 is connected to an obstacle detection system 256 of the autonomous mobile robot 10. The obstacle detection subsystem 256 includes one or more optical, capacitive, inductive, etc. sensors 256S configured to detect other robots and obstacles (e.g. such as walls, racks, human pickers, etc.) within the logistic/manufacturing space 1 in a manner substantially similar to that described in U.S. patent application Ser. No. 14/972,722, previously incorporated by reference herein.

Referring to FIGS. 1A, 1B, and 2, the controller system 258 is connected to an vision system subsystem 270A of the autonomous mobile robot 10. In one aspect the vision system subsystem 270A may include any suitable indicia reader. The vision system subsystem 270A may form, with any suitable indicia 77, the vision system 270. The vision system subsystem 270A and/or the vision system 270 is configured for SLAM navigation (or other suitable navigation) to locate the autonomous mobile robot 10 relative to a store/workpiece (e.g., container) location and/or for maneuvering and travelling of the autonomous mobile robot 10 throughout the logistic/manufacturing space 1. The indicia 77 may be disposed on the array of container holding supports 30 discretely and deterministically locating each container holding space 35 (including elevated container holding spaces 35E) of the array of container holding supports 30 so as to discriminate each container holding space 35 from each other container holding space 35. In another aspect, the indicia may also be disposed on the containers 40; while in still other aspects the indicia may be disposed on both the containers and the array of container holding supports 30. The indicia 77 may be one or more of an optical marker (matrix/two dimensional barcode, barcode, light emitting diodes, etc.), a retroreflective tape, a capacitive marker, an inductive marker, a radio frequency beacon, a radio frequency identification tag, acoustic beacon, and infrared beacon. In one aspect, the vision system subsystem 270A may be integrated with the guidance system 254 so as to reduce a number of sensors provided on the autonomous mobile robot 10.

The controller system 258 is configured to position the autonomous mobile robot 10, so as to transfer a container 40 between a predetermined container holding space 35 and the autonomous mobile robot 10 with the range of motion of the end effector 3000 (FIGS. 3A-3K) at the predetermined container holding space 35 from reading the indicia 77. For example, the controller system 258 is configured to coordinate movement of the end effector 3000 of the articulated pick arm 3060 with movement of the wheeled traverse system 252 to effect transfer of containers to and from the payload holding area 350. In one aspect, the controller system 258 is configured to control movement of the wheeled traverse system 252 based, at least in part, on data received from the vision system 270.

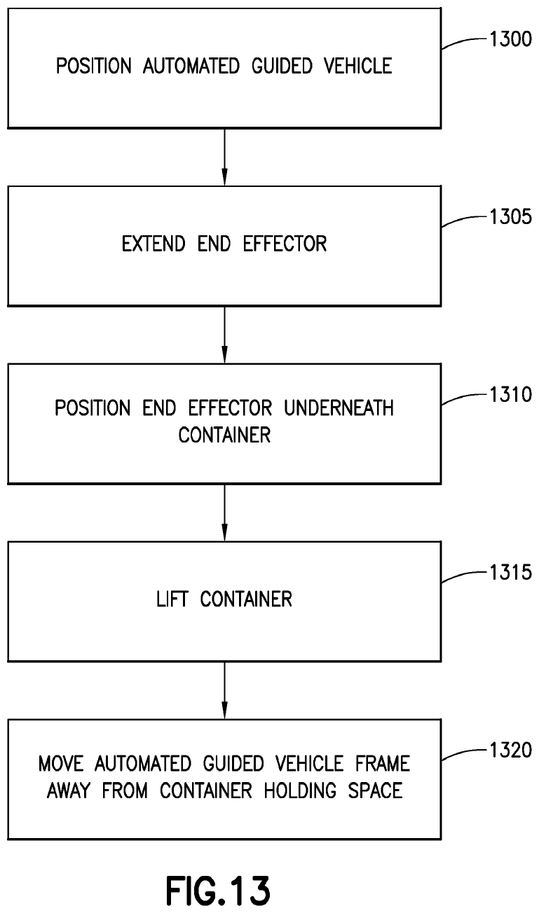

Referring to FIGS. 3A-3F, 3K and 13 the coordinated movement of the end effector 3000 with movement of the wheeled traverse system 252 will be described. The coordinated movement between the end effector 3000 and the wheeled traverse system 252 may be referred to as container holding space address motion and may modify the profile of the arcuate path 3080 with respect to a global reference frame (e.g., the reference frame of the container spaces). More specifically, the arrangement of the manipulator system 260 described above defines a range of motion of the end effector 3000 (and any containers 40 held thereon) that has paths (as described above, e.g., the arcuate path 3080) of limited shape (e.g., the manipulator system 260 compliance is selectively limited) with respect to the autonomous mobile robot payload holding area 350 as may be expected with a one degree of freedom drive. In this aspect, autonomous mobile robot 10 traverse with the wheeled traverse system 252 and guidance system 254 (e.g., any one or combination of guidance system features may be used to position the autonomous mobile robot 10 in the coordinated pick/place motion) is coordinated with and compliments the range of motion of the end effector provided by the manipulator system 260, so that the range of motion of the end effector 3000 (and the transport path of the end effector 3000) with respect to the global reference frame is/are substantially unrestricted. For example, the manipulator system 260 provides the range of motion that extends along the arcuate path 3080, which arcuate path may be modified by the traversal of the autonomous mobile robot 10. For example, referring to FIG. 3A, traversal of the autonomous mobile robot 10 may modify the arcuate path 3080 so that the path has any suitable shape with respect to the global reference frame, such as a substantially linear path 3080′″, or any suitable desired arc 3080′ or combination of an arc and linear path 3080″ to suit the surroundings of the autonomous mobile robot 10. In one aspect, the motion provided by the autonomous mobile robot 10 traversal compliments the articulated pick arm 3060 motion (and the end effector 3000 motion) so that the articulated pick arm 3060 trajectory along the desired path is a time optimal (e.g., bang-bang) path.

In this aspect, the autonomous mobile robot is positioned relative to a predetermined container holding space 35 (FIG. 13, Block 1300) using, for example the guidance system 254 and in accordance with commands of logistic/manufacturing space controller 2. The controller system 258 commands the manipulator system 260 to extend the end effector 3000 (FIG. 13, Block 1305) in direction 3080A from the retracted position shown in FIG. 3A to the extended position shown in FIG. 3B (e.g., for picking a container 40 disposed below the level of the payload seating surface 350S) or to the extended position shown in FIG. 3K (e.g., for picking a container 40 disposed above the level of the payload seating surface 350S). The controller system 258 commands the wheeled traverse system 252 to move the frame 10F and the end effector 3000 in direction 3090 for positioning the end effector 3000 underneath the container 40 disposed in the predetermined container holding space 35 (FIG. 13, Block 1310). The controller system 258 commands the manipulator system 260 to lift or pick the container 40 (FIG. 13, Block 1315) by rotating the articulated pick arm 3060 so that the end effector travels in direction 3080B along an arcuate path 3081. As container 40 is being lifted and retracted into the payload holding area 350 the controller system 258 commands the wheeled traverse system 252 to move the frame 10F in direction 3091 away from the container holding space (FIG. 13, Block 1320) so that as the end effector 3000 and the container 40 held thereon travels along the arcuate path 3081 the arcuate path 3081 is translated in direction 3091 to provide clearance between the container 40 and the array of container holding supports 30 (e.g., to provide an obstruction free retraction path for the container 40 and end effector 3000 between the container holding space 35 and the payload holding area 350). While the lifting of the container 40 and the movement of the frame 10F away from the container holding space 35 is described as being performed substantially simultaneously; in other aspects, the movement of the frame 10F and the retraction of the articulated pick arm 3060 may be sequential such that the frame 10F is moved away from the container holding space 35 with the end effector 3000 in a lowered position (e.g., where the end effector 3000 is raised just enough to lift the container 40 from the container holding space 35 or until further vertical movement of the container 40 is blocked by structure of the array of container holding supports 30) until the container is entirely removed from the container holding space 35 where the retraction of the container 40 into the payload holding area 350 is performed sequentially after removal of the container 40 from the container holding space 35.

In one aspect, referring to FIGS. 1B, 2, and 3A-3G, the controller system 258 may employ signals from the vision system subsystem system 270A for coordinating the movement of the wheeled traverse system 252 while extending or retracting the end effector 3000. For example, the vision system subsystem 270A may be configured, with the controller system 258, to read the indicia 77 and determine one or more of a distance between the end effector 3000 and the container 40 and a distance between the frame 10F and the array of container holding supports 30. The controller system 258 may determine a size (e.g., length LC, width WC, and height HC) of a container 40 based on indicia 77C disposed on the container 40. A distance DS between a lower container holding spaces 35 and elevated container holding spaces 35E may also be known to the controller system 258 in any suitable manner (e.g., such as by indicia 77 disposed on the array of container holding supports 30).

As noted above, the end effector 3000 is held level with the payload seating surface 350S throughout the range of motion of the articulated pick arm 3060 such that the arcuate path 3081 along which the end effector 3000 (and hence the container 40) travels is known. The controller system 258 may be configured or programmed to determine, based on one or more of the location of the end effector 3000, the dimensions of the container 40 held thereon and the distance between the frame 10F and the array of container holding supports 30, the relative position between the container 40 carried by the end effector 3000 and the structure of the array of container holding supports 30 (e.g., such as the supports of the elevated container holding spaces 35E) throughout the range of motion of the articulated pick arm 3060. Based on the relative position between the container 40 and the structure of the array of container holding supports 30 the controller system 258 controls the wheeled traverse system 252 to move the frame 10F of the autonomous mobile robot 10 away from the array of container holding supports 30 while retracting the end effector 3000 and the container 40 held thereon into the payload holding area 350. In one aspect, the movement of the frame 10F away from the array of container holding supports 30 and the retraction of the articulated pick arm 3060 may be coordinated so as to limit an amount of retract movement of the end effector 3000 that is performed outside the bounds of the array of container holding supports 30 (e.g., to limit exposure of the moving end effector 3000 to any human pickers HP in the aisles 50—see FIG. 1A). As may be realized, placement of the container 40 into the container holding space 35 may be performed in substantially opposite manner described above for picking the container 40 from the container holding space 35.

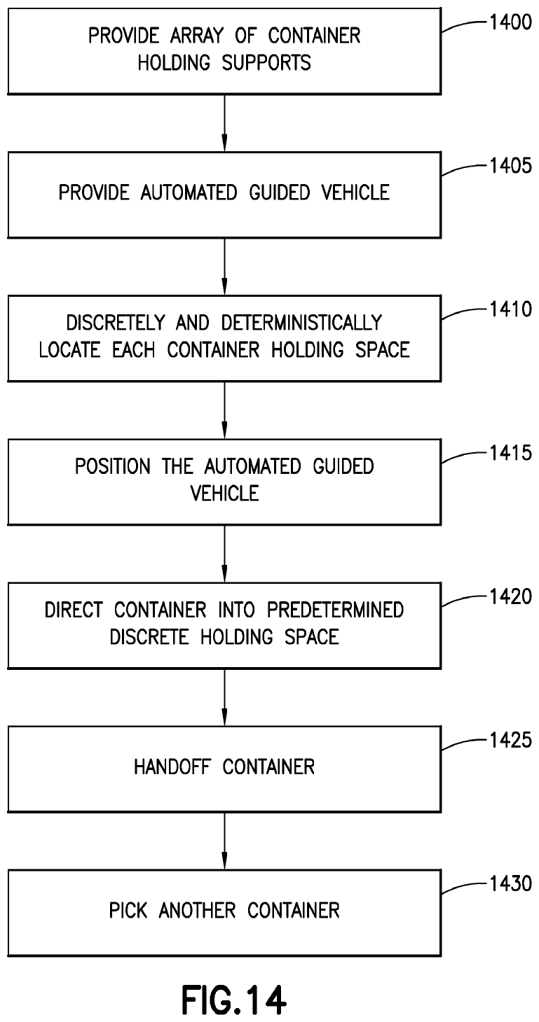

Referring to FIGS. 1A-3G, and 14 an exemplary method for transporting and storing container in the automated management system 55 will be described. The method includes providing an array of container holding supports 30 (FIG. 14, Block 1400) with container holding spaces 35 distributed in a logistic/manufacturing space 1. The autonomous mobile robot(s) 10 (described herein) are also provided (FIG. 14, Block 1405). In this aspect, each container holding space 35 of the array of container holding supports 30 is discretely and deterministically locating (FIG. 14, Block 1410) with an vision system 270 having indicia 77 disposed on the array of container holding supports 30 so as to discriminate each container holding space 35 from each other container holding space 35. Here, indicia 77 discriminate discrete container holding support spaces 35 independent of other structural features of the container holding supports 30 (e.g., guiding inserts 150).

The autonomous mobile robot 10 is positioned (FIG. 14, Block 1415), with the controller system 258 connected to the autonomous mobile robot 10 and the vision system 270, so as to transfer a container 40 between a predetermined container holding space 35 and the autonomous mobile robot 10 with the range of motion of the end effector 3000 at the predetermined container holding space 35 from reading the indicia 77. For example, the autonomous mobile robot 10 may receive commands from the logistic/manufacturing space controller 2 for picking a container, where the command includes a location of the container 40 in the logistic/manufacturing space 1. The autonomous mobile robot 10 traverses the logistic/manufacturing space 1 to the predetermined location of the container 40 with input from one or more of the guidance system 254, the obstacle detection system 256, and the vision system 270. The autonomous mobile robot 10 may align itself with the container holding space 35 using, for example, the vision system subsystem 270A by reading the indicia 77, 77C. The end effector 3000 is extended from the retracted position/configuration shown in FIG. 3A to the extended position/configuration shown in FIG. 3B. The autonomous mobile robot moves in direction 3090 (FIG. 3D) to place the end effector 3000 underneath the container 40 in the container holding space 35.

As described above, the transferring of the container 40 between the autonomous mobile robot 10 and the container holding space 35 (for either picking or placement of the container 40) may include coordinating, with the controller system 258, movement of the end effector 3000 of the articulated pick arm 3060 with movement of the wheeled traverse system 252 to effect transfer of the container(s) 40 to and from the payload holding area 350. In one aspect, movement of the wheeled traverse system 252 is controlled with the controller system 258 based, at least in part, on data received from the vision system 270 (as described herein). As described above, the container 40 held by the end effector 3000 is transported throughout the range of motion of the end effector 3000 to place the container 40 in the container holding area 350 as illustrated in FIGS. 3E-3G and 3K, where the container 40 is engaged by the end effector 3000 from undersides of the container 40. In one aspect, as described above, the range of motion of the end effector 3000 spans from an elevation below a lowermost level of the payload seating surface 350S (see, e.g., FIG. 3D) onto the payload seating surface 350S; while in other aspects, the range of motion of the end effector 3000 spans from an elevation above a level of the payload seating surface 350S (see FIG. 3K) onto the payload seating surface 350S. In one aspect, where the range of motion spans from an elevation above a level of the payload seating surface 350S (see FIG. 3K) onto the payload seating surface 350S, at least a portion 10FP of the autonomous mobile robot 10 (or substantially the entire frame 10F of the autonomous mobile robot 10) is raised or lowered with another motor 3001M2, of the at least one drive section 3001 as described herein.

In one aspect, the method also includes directing the container 40 held by end effector 3000 into a predetermined discrete container holding space 35 (FIG. 14, Block 1420), on end effector 3000 placement of the container 40 into the predetermined discrete container holding space 35, with guiding inserts 150 disposed at respective container holding spaces 35 of the array of container holding supports 30. In one aspect, the guiding inserts 150 discriminate each container holding space 35 from another container holding space 35.

In one aspect, the articulated pick arm 3060 is decoupled from the payload seating surface 350S as described above. Where the articulated pick arm 3060 is decoupled from the payload seating surface 350S, referring also to FIGS. 3H-3J, the method may also include handing off the container 40, held and transported by the end effector 3000, from the end effector 3000 onto the payload seating surface 350S (FIG. 14, Block 1425) as illustrated in FIG. 3H. As described above, the handoff of the container 40 may be effected by the handoff mechanism 3999. Another container 40A is picked (FIG. 14, Block 1430) with the end effector 3000 within the range of motion of the end effector 3000 (in the manner described above) with the container 40 in the payload holding area 350 as illustrated in FIGS. 3I and 3J.

In accordance with one or more aspects of the present disclosure an autonomous mobile robot comprises:

a frame defining a payload holding area with a payload seating surface, and having a wheeled traverse system dependent from the frame for substantially free unrestricted roving of the autonomous mobile robot on a riding surface in a facility space;

at least one drive section connected to the frame, and having at least one motor defining at least one independent degree of freedom; and

an articulated pick arm dependent from the frame, the articulated pick arm having an end effector configured so as to stably hold a container therewith, and being operably connected to the at least one motor so that the at least one independent degree of freedom extends and retracts the articulated pick arm, and raises and lowers the articulated pick arm defining a range of motion of the end effector spanning from an elevation below a lowermost level of the payload seating surface onto the payload seating surface.

In accordance with one or more aspects of the present disclosure the articulated pick arm is configured to transport the container held by the end effector throughout the range of motion of the end effector.

In accordance with one or more aspects of the present disclosure the container has sides that are grab free, and the end effector is an underpicking end effector, engaging with undersides of the container so as to hold the container.

In accordance with one or more aspects of the present disclosure the articulated pick arm is decoupled from the payload seating surface, so as to handoff the container, held and transported by the end effector, from the end effector onto the payload seating surface, and pick another container with the end effector within the range of motion of the end effector with the container in the payload holding area.

In accordance with one or more aspects of the present disclosure the range of motion of the end effector spans from an elevation above a level of the payload seating surface onto the payload seating surface.

In accordance with one or more aspects of the present disclosure the at least one drive section has another motor defining another independent degree of freedom for raising or lowering the autonomous mobile robot.

In accordance with one or more aspects of the present disclosure the at least one drive section has another motor defining another independent degree of freedom for raising or lowering at least a portion of the autonomous mobile robot.

In accordance with one or more aspects of the present disclosure the autonomous mobile robot further comprises a controller configured to coordinate movement of the end effector of the articulated pick arm with movement of the wheeled traverse system to effect transfer of containers to and from the payload holding area.

In accordance with one or more aspects of the present disclosure an autonomous mobile robot comprises:

a frame defining a payload holding area with a payload seating surface, and having a wheeled traverse system dependent from the frame for substantially free unrestricted roving of the autonomous mobile robot on a riding surface in a facility space;

at least one drive section connected to the frame, and having at least one motor defining at least one independent degree of freedom; and

a swivel pick arm dependent from the frame, the swivel pick arm having an end effector configured so as to stably hold a container therewith, and being operably connected to the at least one motor so that the at least one independent degree of freedom extends and retracts the swivel pick arm, and raises and lowers the swivel pick arm defining a range of motion of the end effector relative to the payload seating surface;

wherein the end effector is synchronized with respect to at least another part of the swivel pick arm so that the end effector holds the container level so as to be aligned with the payload seating surface at each position of the end effector from the payload seating surface throughout the range of motion of the end effector.

In accordance with one or more aspects of the present disclosure the range of motion of the end effector spans from an elevation below a lowermost level of the payload seating surface onto the payload seating surface.

In accordance with one or more aspects of the present disclosure the swivel pick arm is configured to transport the container held by the end effector throughout the range of motion of the end effector.

In accordance with one or more aspects of the present disclosure the container has sides that are grab free, and the end effector is an underpicking end effector, engaging with undersides of the container so as to hold the container.

In accordance with one or more aspects of the present disclosure the swivel pick arm is decoupled from the payload seating surface, so as to handoff the container, held and transported by the end effector, from the end effector onto the payload seating surface, and pick another container with the end effector within the range of motion of the end effector with the container in the payload holding area.

In accordance with one or more aspects of the present disclosure the range of motion of the end effector spans from an elevation above a level of the payload seating surface onto the payload seating surface.

In accordance with one or more aspects of the present disclosure the at least one drive section has another motor defining another independent degree of freedom for raising or lowering the autonomous mobile robot.

In accordance with one or more aspects of the present disclosure the at least one drive section has another motor defining another independent degree of freedom for raising or lowering at least a portion of the autonomous mobile robot.

In accordance with one or more aspects of the present disclosure the autonomous mobile robot further comprises a controller configured to coordinate movement of the end effector of the swivel pick arm with movement of the wheeled traverse system to effect transfer of containers to and from the payload holding area.

In accordance with one or more aspects of the present disclosure an autonomous mobile robot comprises:

a frame defining a payload holding area with a payload seating surface, and having a wheeled traverse system dependent from the frame for substantially free unrestricted roving of the autonomous mobile robot on a riding surface in a facility space;

at least one drive section connected to the frame, and having at least one motor defining at least one independent degree of freedom; and

a swivel pick arm dependent from the frame, the swivel pick arm having an end effector configured for friction container transfer handling, and being operably connected to the at least one motor so that the at least one independent degree of freedom extends and retracts the swivel pick arm, and raises and lowers the swivel pick arm defining a range of motion of the end effector relative to the payload seating surface;

wherein the end effector is synchronized with respect to at least another part of the swivel pick arm so that the end effector holds the container level so as to be aligned with the payload seating surface at each position of the end effector from the payload seating surface throughout the range of motion of the end effector.

In accordance with one or more aspects of the present disclosure the range of motion of the end effector spans from an elevation below a lowermost level of the payload seating surface onto the payload seating surface.

In accordance with one or more aspects of the present disclosure the swivel pick arm is configured to transport the container held by the end effector throughout the range of motion of the end effector.

In accordance with one or more aspects of the present disclosure the container has sides that are grab free, and the end effector is an underpicking end effector configured to frictionally engage with undersides of the container so as to stably hold the container.

In accordance with one or more aspects of the present disclosure the swivel pick arm is decoupled from the payload seating surface, so as to handoff the container, held and transported by the end effector, from the end effector onto the payload seating surface, and pick another container with the end effector within the range of motion of the end effector with the container in the payload holding area.

In accordance with one or more aspects of the present disclosure the range of motion of the end effector spans from an elevation above a level of the payload seating surface onto the payload seating surface.

In accordance with one or more aspects of the present disclosure the at least one drive section has another motor defining another independent degree of freedom for raising or lowering the autonomous mobile robot.

In accordance with one or more aspects of the present disclosure the at least one drive section has another motor defining another independent degree of freedom for raising or lowering at least a portion of the autonomous mobile robot.

In accordance with one or more aspects of the present disclosure the autonomous mobile robot further comprises a controller configured to coordinate movement of the end effector of the swivel pick arm with movement of the wheeled traverse system to effect transfer of containers to and from the payload holding area.

In accordance with one or more aspects of the present disclosure an automated management system comprises:

an array of container holding supports with container holding spaces distributed in a logistic/manufacturing space;

an autonomous mobile robot including

a frame defining a payload holding area with a payload seating surface, and having a wheeled traverse system dependent from the frame for substantially free unrestricted roving of the autonomous mobile robot on a riding surface in a facility space,

at least one drive section connected to the frame, and having at least one motor defining at least one independent degree of freedom, and

an articulated pick arm dependent from the frame, the articulated pick arm having an end effector configured so as to stably hold a container therewith, and being operably connected to the at least one motor so that the at least one independent degree of freedom extends and retracts the articulated pick arm, and raises and lowers the articulated pick arm defining a range of motion of the end effector spanning from an elevation below a lowermost level of the payload seating surface onto the payload seating surface;

a vision system having indicia disposed on the array of container holding supports discretely and deterministically locating each container holding space of the array of container holding supports so as to discriminate each container holding space from each other container holding space; and

a controller connected to autonomous mobile robot and the vision system, the controller being configured to position the autonomous mobile robot, so as to transfer a container between a predetermined container holding space and the autonomous mobile robot with the range of motion of the end effector at the predetermined holding space from reading the indicia.

In accordance with one or more aspects of the present disclosure the automated management system further comprises guiding inserts disposed at respective container holding spaces of the array of container holding supports, the guiding inserts discriminating each container holding space from another container holding space, and defining at least one guide surface configured to direct the container held by end effector into a predetermined discrete holding space on end effector placement of the container into the predetermined discrete holding space.

In accordance with one or more aspects of the present disclosure the indicia comprises one or more of an optical marker, a retroreflective tape, a capacitive marker, an inductive marker, a radio frequency beacon, a radio frequency identification tag, an identification tag/marker, acoustic beacon, and infrared beacon.

In accordance with one or more aspects of the present disclosure the articulated pick arm is configured to transport the container held by the end effector throughout the range of motion of the end effector.

In accordance with one or more aspects of the present disclosure the container has sides that are grab free, and the end effector is an underpicking end effector, engaging with undersides of the container so as to hold the container.

In accordance with one or more aspects of the present disclosure the articulated pick arm is decoupled from the payload seating surface, so as to handoff the container, held and transported by the end effector, from the end effector onto the payload seating surface, and pick another container with the end effector within the range of motion of the end effector with the container in the payload holding area.

In accordance with one or more aspects of the present disclosure the range of motion of the end effector spans from an elevation above a level of the payload seating surface onto the payload seating surface.

In accordance with one or more aspects of the present disclosure the at least one drive section has another motor defining another independent degree of freedom for raising or lowering the autonomous mobile robot.

In accordance with one or more aspects of the present disclosure the at least one drive section has another motor defining another independent degree of freedom for raising or lowering at least a portion of the autonomous mobile robot.

In accordance with one or more aspects of the present disclosure the controller is configured to coordinate movement of the end effector of the articulated pick arm with movement of the wheeled traverse system to effect transfer of containers to and from the payload holding area.

In accordance with one or more aspects of the present disclosure the controller is configured to control movement of the wheeled traverse system based, at least in part, on data received from the vision system.

In accordance with one or more aspects of the present disclosure a method for transporting and storing containers in an automated management system is provided. The method comprises:

providing an array of container holding supports with container holding spaces distributed in a logistic/manufacturing space;

providing an autonomous mobile robot including

a frame defining a payload holding area with a payload seating surface, and having a wheeled traverse system dependent from the frame for substantially free unrestricted roving of the autonomous mobile robot on a riding surface in a facility space,

at least one drive section connected to the frame, and having at least one motor defining at least one independent degree of freedom, and

an articulated pick arm dependent from the frame, the articulated pick arm having an end effector configured so as to stably hold a container therewith, and being operably connected to the at least one motor so that the at least one independent degree of freedom extends and retracts the articulated pick arm, and raises and lowers the articulated pick arm defining a range of motion of the end effector spanning from an elevation below a lowermost level of the payload seating surface onto the payload seating surface;

discretely and deterministically locating each container holding space of the array of container holding supports with a vision system having indicia disposed on the array of container holding supports so as to discriminate each container holding space from each other container holding space; and

positioning the autonomous mobile robot, with a controller connected to the autonomous mobile robot and the vision system, so as to transfer a container between a predetermined container holding space and the autonomous mobile robot with the range of motion of the end effector at the predetermined holding space from reading the indicia.

In accordance with one or more aspects of the present disclosure the method further comprises coordinating, with the controller, movement of the end effector of the articulated pick arm with movement of the wheeled traverse system to effect transfer of containers to and from the payload holding area.

In accordance with one or more aspects of the present disclosure the method further comprises controlling movement of the wheeled traverse system with the controller based, at least in part, on data received from the vision system.

In accordance with one or more aspects of the present disclosure the method further comprises directing the container held by end effector into a predetermined discrete holding space, on end effector placement of the container into the predetermined discrete holding space, with guiding inserts disposed at respective container holding spaces of the array of container holding supports, the guiding inserts discriminating each container holding space from another container holding space.

In accordance with one or more aspects of the present disclosure the method further comprises transporting the container held by the end effector throughout the range of motion of the end effector.

In accordance with one or more aspects of the present disclosure the method further comprises engaging undersides of the container with the end effector so as to hold the container, wherein the container has sides that are grab free and the end effector is an underpicking end effector.

In accordance with one or more aspects of the present disclosure the method further comprises:

handing off the container, held and transported by the end effector, from the end effector onto the payload seating surface; and

picking another container with the end effector within the range of motion of the end effector with the container in the payload holding area;

wherein the articulated pick arm is decoupled from the payload seating surface.

In accordance with one or more aspects of the present disclosure the range of motion of the end effector spans from an elevation above a level of the payload seating surface onto the payload seating surface.

In accordance with one or more aspects of the present disclosure the method further comprises raising or lowering the autonomous mobile robot with another motor, of the at least one drive section, that defines another independent degree of freedom for raising or lowering the autonomous mobile robot.

In accordance with one or more aspects of the present disclosure the method further comprises raising or lowering at least a portion of the autonomous mobile robot with another motor, of the at least one drive section, that defines another independent degree of freedom for raising or lowering the portion of the autonomous mobile robot.

It should be understood that the foregoing description is only illustrative of the aspects of the present disclosure. Various alternatives and modifications can be devised by those skilled in the art without departing from the aspects of the present disclosure. Accordingly, the aspects of the present disclosure are intended to embrace all such alternatives, modifications and variances that fall within the scope of any claims appended hereto. Further, the mere fact that different features are recited in mutually different dependent or independent claims does not indicate that a combination of these features cannot be advantageously used, such a combination remaining within the scope of the aspects of the present disclosure.

What is claimed is:

1. An autonomous mobile robot comprising: a frame defining a payload holding area with a payload seating surface, and having a wheeled traverse system dependent from the frame for substantially free unrestricted roving of the autonomous mobile robot on a riding surface in a facility space; at least one drive section connected to the frame, and having at least one motor defining at least one independent degree of freedom; and
an articulated pick arm dependent from the frame, the articulated pick arm having an end effector configured so as to stably hold a container therewith, and being operably connected to the at least one motor so that the at least one independent degree of freedom extends and retracts the articulated pick arm, and raises and lowers the articulated pick arm defining a range of motion of the end effector spanning from an elevation below a lowermost level of the payload seating surface onto the payload seating surface.

2. The autonomous mobile robot of claim 1, wherein the articulated pick arm is configured to transport the container held by the end effector throughout the range of motion of the end effector.

3. The autonomous mobile robot of claim 1, wherein the container has sides that are grab free, and the end effector is an underpicking end effector, engaging with undersides of the container so as to hold the container.

4. The autonomous mobile robot of claim 1, wherein the articulated pick arm is decoupled from the payload seating surface, so as to handoff the container, held and transported by the end effector, from the end effector onto the payload seating surface, and pick another container with the end effector within the range of motion of the end effector with the container in the payload holding area.

5. The autonomous mobile robot of claim 1, wherein the range of motion of the end effector spans from an elevation above a level of the payload seating surface onto the payload seating surface.

6. The autonomous mobile robot of claim 1, wherein the at least one drive section has another motor defining another independent degree of freedom for raising or lowering the autonomous mobile robot.

7. The autonomous mobile robot of claim 1, wherein the at least one drive section has another motor defining another independent degree of freedom for raising or lowering at least a portion of the autonomous mobile robot.

8. The autonomous mobile robot of claim 1, further comprising a controller configured to coordinate movement of the end effector of the articulated pick arm with movement of the wheeled traverse system to effect transfer of containers to and from the payload holding area.

9-26. (canceled)

27. An automated management system comprising:
an array of container holding supports with container holding spaces distributed in a logistic/manufacturing space;
an autonomous mobile robot including
a frame defining a payload holding area with a payload seating surface, and having a wheeled traverse system dependent from the frame for substantially free unrestricted roving of the autonomous mobile robot on a riding surface in a facility space,
at least one drive section connected to the frame, and having at least one motor defining at least one independent degree of freedom, and
an articulated pick arm dependent from the frame, the articulated pick arm having an end effector configured so as to stably hold a container therewith, and being operably connected to the at least one motor so that the at least one independent degree of freedom extends and retracts the articulated pick arm, and raises and lowers the articulated pick arm defining a range of motion of the end effector spanning from an elevation below a lowermost level of the payload seating surface onto the payload seating surface;
an vision system having indicia disposed on the array of container holding supports discretely and deterministically locating each container holding space of the array of container holding supports so as to discriminate each container holding space from each other container holding space; and
a controller connected to autonomous mobile robot and the vision system, the controller being configured to position the autonomous mobile robot, so as to transfer a container between a predetermined container holding space and the autonomous mobile robot with the range of motion of the end effector at the predetermined holding space from reading the indicia.

28. The automated management system of claim 27, further comprising guiding inserts disposed at respective container holding spaces of the array of container holding supports, the guiding inserts discriminating each container holding space from another container holding space, and defining at least one guide surface configured to direct the container held by end effector into a predetermined discrete holding space on end effector placement of the container into the predetermined discrete holding space.

29. The automated management system of claim 27, wherein the indicia comprises one or more of an optical marker a retroreflective tape, a capacitive marker, an inductive marker, a radio frequency beacon, a radio frequency identification tag, acoustic beacon, and infrared beacon.

30. The automated management system of claim 27, wherein the articulated pick arm is configured to transport the container held by the end effector throughout the range of motion of the end effector.

31. The automated management system of claim 27, wherein the container has sides that are grab free, and the end effector is an underpicking end effector, engaging with undersides of the container so as to hold the container.

32. The automated management system of claim 27, wherein the articulated pick arm is decoupled from the payload seating surface, so as to handoff the container, held and transported by the end effector, from the end effector onto the payload seating surface, and pick another container with the end effector within the range of motion of the end effector with the container in the payload holding area.

33. The automated management system of claim 27, wherein the range of motion of the end effector spans from an elevation above a level of the payload seating surface onto the payload seating surface.

34-37. (canceled)

38. A method for transporting and storing containers in an automated management system, the method comprising:
providing an array of container holding supports with container holding spaces distributed in a logistic/manufacturing space;
providing an autonomous mobile robot including
a frame defining a payload holding area with a payload seating surface, and having a wheeled traverse system dependent from the frame for substantially free unrestricted roving of the autonomous mobile robot on a riding surface in a facility space,
at least one drive section connected to the frame, and having at least one motor defining at least one independent degree of freedom, and
an articulated pick arm dependent from the frame, the articulated pick arm having an end effector configured so as to stably hold a container therewith, and being operably connected to the at least one motor so that the at least one independent degree of freedom extends and retracts the articulated pick arm, and raises and lowers the articulated pick arm defining a range of motion of the end effector spanning from an elevation below a lowermost level of the payload seating surface onto the payload seating surface;
discretely and deterministically locating each container holding space of the array of container holding supports with an vision system having indicia disposed on the array of container holding supports so as to discriminate each container holding space from each other container holding space; and
positioning the autonomous mobile robot, with a controller connected to the autonomous mobile robot and the vision system, so as to transfer a container between a predetermined container holding space and the autonomous mobile robot with the range of motion of the end effector at the predetermined holding space from reading the indicia.

39. The method of claim 38, further comprising coordinating, with the controller, movement of the end effector of the articulated pick arm with movement of the wheeled traverse system to effect transfer of containers to and from the payload holding area.

40. (canceled)

41. The method of claim 38, further comprising directing the container held by end effector into a predetermined discrete holding space, on end effector placement of the container into the predetermined discrete holding space, with guiding inserts disposed at respective container holding spaces of the array of container holding supports, the guiding inserts discriminating each container holding space from another container holding space.

42-43. (canceled)

44. The method of claim 38, further comprising:
handing off the container, held and transported by the end effector, from the end effector onto the payload seating surface; and
picking another container with the end effector within the range of motion of the end effector with the container in the payload holding area;
wherein the articulated pick arm is decoupled from the payload seating surface.

45-46. (canceled)

47. The method of claim 38, further comprising raising or lowering at least a portion of the autonomous mobile robot with another motor, of the at least one drive section, that defines another independent degree of freedom for raising or lowering the portion of the autonomous mobile robot.
